(19) United States
(12) Patent Application Publication
(10) Pub. No.: US 2012/0246029 A1
(43) Pub. Date: Sep. 27, 2012

(54) PRODUCT COMPARISON AND SELECTION SYSTEM AND METHOD

(76) Inventor: Mark D. Ventrone, Chicago, IL (US)

(21) Appl. No.: 13/408,662

(22) Filed: Feb. 29, 2012

Related U.S. Application Data
(60) Provisional application No. 61/467,514, filed on Mar. 25, 2011.

(51) Int. Cl. G06Q 30/06

(52) U.S. Cl. 705/26.63; 705/26.64

(57) ABSTRACT

A computerized product comparison and selection system configured to communicate with a plurality of product provider systems and a plurality of user access devices, and configured to enable a user of one of the user access devices to sequentially compare sets of different product images of a selected product type to determine user preferences for the various characteristics of the product type. A specific product is determined by the system by inferentially defining and identifying the user's preferences through analysis of visual product images selected by the user.

### PRIORITY CLAIM

This patent application is a non-provisional of, claims priority to, and the benefit of U.S. Provisional Parent Application Ser. No. 61/467,514 filed Mar. 25, 2011, the entire contents of which are incorporated herein.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

A consumer desiring to purchase a product may have only a general idea of the product desired or may have a specific product in mind. If the consumer has a specific product in mind, the consumer will generally know most if not all of the characteristics of that specific product. If a consumer just has a general idea of the product or the product type the consumer wishes to purchase, the consumer may know little or some, but not all of the characteristics, of the desired product.

Whichever category the consumer falls under, the marketplace currently enables the consumer to: (1) physically go to one or more retailer or wholesaler establishments to look for the product; (2) review paper catalogs from one or more retailers, wholesalers or other product distributors or providers; or (3) search on the internet for the desired product. Each of these currently known methods has various advantages and disadvantages.

More specifically, physically going to one or more retailers or wholesalers to look for a desired product has several advantages and disadvantages. Certain advantages are: (1) many consumers enjoy physically going to stores to look for products; and (2) in each store, consumers can physically see, touch, try on, test, match, and compare various products in that store. Certain disadvantages are: (1) going to stores is time consuming and can make a search for a specific product relatively long unless the consumer knows exactly what product the consumer wants and which store sells that specific product; (2) the consumer is generally limited to local shopping; (3) the consumer may have to go to many stores to find the specific product that consumer wants; (4) the consumer can waste fuel or energy (and money) going to one or more stores; (5) the consumer can be pestered by sales associates in the stores; (6) the consumer may be limited by bad weather; and (7) the consumer can only go to a store during store hours.

Reviewing paper catalogs from one or more retailers or wholesalers to select a product also has several advantages and disadvantages. Certain advantages are: (1) the consumer can take time in the comfort of her own home looking through catalogs; and (2) the consumer can generally look through a couple of catalogs very quickly. Certain disadvantages are: (1) going through numerous catalogs can be time consuming; (2) the production and distribution of catalogs uses a large amount of natural resources, energy, and is environmentally damaging when the catalogs wind up in land fills; and (3) even when a product is selected, the consumer will still need to take the additional step of calling, going online, or going to a store to purchase the product anyway,

Currently, searching on the internet for products also has several advantages and disadvantages. Certain advantages are: (1) shopping on the internet is generally more time efficient than physically going to a store or looking at product catalogs; (2) internet shopping generally provides quick access to many products; and (3) shopping on the internet does not require a user to consume transportation related fuel and does not create transportation related environmental waste. Certain disadvantages are: (1) the internet is saturated with so many retail sites; (2) the consumer cannot physically examine a product; (3) searching multiple web sites for products can be time consuming especially when the consumer does not know the specific product the consumer is looking for; (4) it is often difficult for a consumer to compare products from different web sites; (5) many web sites found in searches sometimes have limited product descriptions or information; and (6) many internet searches for products result in thousands of results or hits, especially when a generic term is used instead of a specific product name.

Thus, while the internet is a good tool that enables consumers to avoid the time consuming task of leaving their homes to search for products and enables consumers to locate many products more quickly, due to the inundation of retail web sites on the internet, searching for products on the internet can still be a time consuming task especially when a consumer does not know the specific product that the consumer wants to purchase.

Accordingly, there is a need for a better way to enable consumers to compare, select, and purchase products, and specifically to use the internet to compare, select, and purchase products.

### SUMMARY

The present disclosure solves the above problems by providing an easy to use computerized product comparison and selection system and method. The computerized system and method enables a user to view sets of comparative visual images of different versions of products which are of a selected product type that the user is looking for: (i) to select the preferred displayed visual image from each set of comparative visual product images, (ii) to methodically define characteristics of a desired product of the product type by step by step narrowing the scope of the desired product characteristics, and thus (iii) to eventually select a specific product with preferred characteristics for purchase. In certain embodiments, the computerized product comparison and selection system and method also enables the user to purchase the selected product through the system. In other embodiments, the computerized product comparison and selection system and method directs the user to another virtual location (such as a web site) or to a physical location (such as a retailer store) to enable the user to purchase the selected product.

The computerized product comparison and selection system and method of the present disclosure enables users to quickly identify a desired product by refining user preferences through comparative visual product images that will enable the user to directly or inferentially define such preferences. As preferences are keenly defined, each subsequent set of comparative visual product images assist in bringing the user closer to the desired specific product.

In various embodiments, the computerized product comparison and selection system and method of the present disclosure provides a product driven web site and/or application that enable users (such as consumers) to easily, quickly, and efficiently define the various characteristics of a product type they are looking for and to find a specific product that meets all or most of the defined characteristics of that product type. The computerized product comparison and selection system and method also enables a user that knows one, some, or all of the major characteristics of a product they prefer or are looking for to easily find specific products which fit those characteristics. The computerized product comparison and selection system and method also makes the product search an enjoyable interactive activity rather than a tedious, time consuming, mundane task.

Other objects, features and advantages of the present invention will be apparent from the following detailed disclosure, taken in conjunction with the accompanying sheets of drawings, wherein like reference numerals refer to like parts.

### BRIEF DESCRIPTION OF THE FIGURES

FIG. 1 is a schematic high level diagram of one embodiment of the product comparison and selection system of the present disclosure and the interaction of the system with product providers and user access devices.

FIG. 1A is a schematic high level diagram of one embodiment of the product comparison and selection system of the present disclosure.

FIGS. 2A, 2B, 2C, 2D, 2E, and 2F are example user interface screens or web pages illustrating certain of the basic functionality of the product comparison and selection system of the present disclosure.

FIGS. 3A, 3B, 3C, 3D, 3E, and 3F are example user interface screens or web pages illustrating certain of the basic functionality of the product comparison and selection system of the present disclosure.

FIGS. 4A, 4B, 4C, 4D, 4E, 4F, 4G, 4H, 4I, and 4J are a series of user interface screens or web pages of another example embodiment of the product comparison and selection system of the present disclosure.

FIGS. 5A, 5B, 5C, 5D, 5E, 5F, 5G, 5H, 5I, 5J, and 5K are a series of user interface screens or web pages of another example embodiment of the product comparison and selection system of the present disclosure.

FIGS. 6A, 6B, 6C, 6D, 6E, 6F, and 6G are a series of user interface screens or web pages of another example embodiment of the product comparison and selection system of the present disclosure.

### DETAILED DESCRIPTION

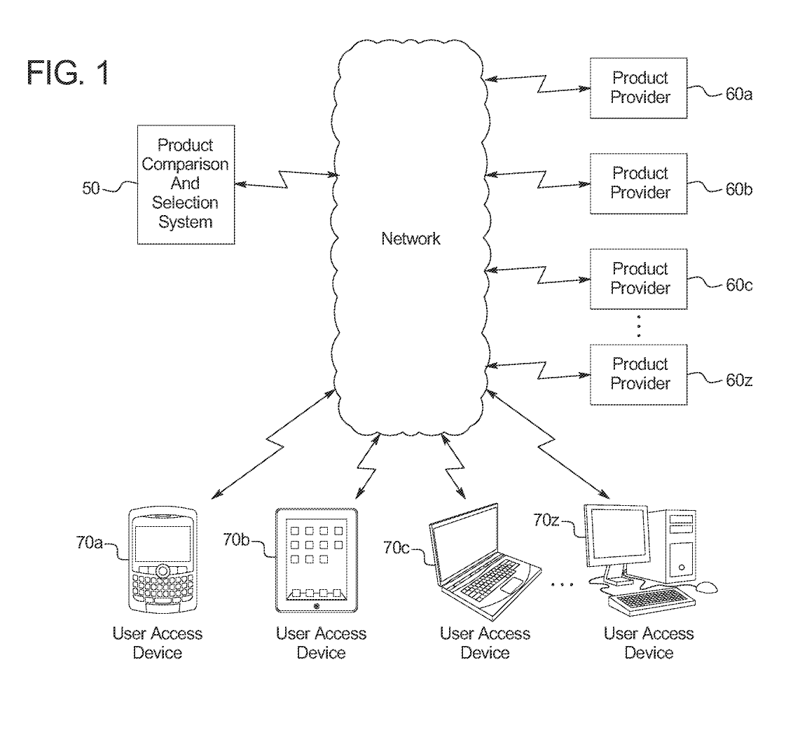

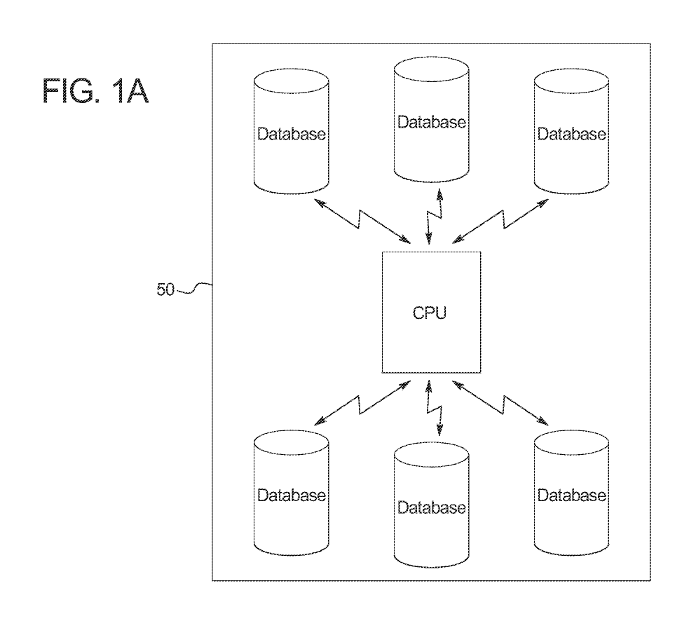

Referring now to the drawings and particularly to FIGS. 1 and 1A, one embodiment of the computerized product comparison and selection system of the present disclosure is generally illustrated and indicated by numeral 50. For brevity, the product comparison and selection system of the present disclosure may be sometimes referred to herein as the product comparison system, the product selection system, or simply the system. It should also be appreciated that this application primarily discusses the functions that the computerized product comparison and selection system performs, and that the method of the present disclosure includes various combinations of the performance or operation of these functions.

In various embodiments, the product selection system such as product selection system 50 is configured to communicate with one or more product provider systems such as product provider systems 60a, 60b, 60c, . . . 60z and with one or more user access devices such as user access devices 70a, 70b, 70c, . . . 70z. The product selection system includes one or more computers (such as servers which include one or more central processing units 52 and one or more memory devices which store databases such as databases 54a, 54b, 54c, 54d, 54e, and 54f) as further discussed below. The product provider systems each include one or more computers (such as servers) as further discussed below. The user access devices each include one or more computers (such as but not limited to desktop personal computers, laptop computers, smart phones, tablet computing devices, and personal digital assistants) as further discussed below. Users operate the user access devices to access the product selection system. In certain embodiments, the product selection systems are integrated into the product provider system(s) or operate as one system as further discussed below. It should be appreciated that at least part of the system can be provided or implemented on user access devices through one or more applications downloaded to those devices (i.e., commonly called “apps”).

In various embodiments, the product selection system is configured to enable users to use the user access devices to access the system through the internet. In certain embodiments, any person can access the system as a user by going to the home page of the system in a conventional manner. In certain embodiments, the users do not need to identify themselves to use the system. In other embodiments, the system requires the users to identify themselves to use the system. In certain embodiments, the system requires the users to register with the system by inputting a user identifier (such as a name or e-mail address) and a password to use the system. In other embodiments, the system requires additional information from the user to access and use the system. In other embodiments, the system requires a user to become a member of the system or a member of a club of or associated with an entity operating the system to use the system. In certain embodiments, the system provides one or more benefits or additional features to the user if the user identifies themselves or is a member of the system or a member of a club of or associated with the entity operating the system. In certain embodiments, the system requires a user to pay one or more fees for accessing or using the system. In the embodiments where the user is identified, the system can be configured to save user information such as product search results or parts thereof for subsequent access and use by the user. It should thus be appreciated that the product comparison and selection system can be implemented in a variety of different manners in regard to access and use of the system by users in accordance with the present disclosure. It should also be appreciated that the system can be implemented by different types of operators such as, but not limited to, product sellers, product retailers, product wholesalers, product distributors, and product manufacturers,

The product comparison and selection system of the present disclosure, when accessed by a user access device, causes the user access device to display certain images and/or information to the user and enables the user to make certain inputs. Similarly, if the product comparison and selection system is implemented in whole or part through an application downloaded to the user access device, the application causes the user access device to display certain images and/or information to the user and enables the user to make certain inputs. For brevity, throughout this application, instead of stating that the product selection system (or application thereof) causes the user access device to display images and/or information to the user, the present application often simply states or explains this by stating that the system displays images and/or information to the user. Similarly, for brevity, instead of stating that the product selection system (or application thereof) causes the user access device to enable the user to make inputs (such as picking images or making other inputs), the present application often states or explains this by stating that the system enables the user to pick images and/or make other inputs of information. It should be appreciated that such statements are for brevity and not meant to limit the scope of the present disclosure.

Very generally, in certain embodiments, the product selection system: (1) uses product data from one or more of the product provider systems (which for purposes of this application include any suitable product information source); (2) enables the user to select or input a product type that the user is looking for or looking to purchase; (3) causes the sequential display to the user of a plurality of sets of comparative product images of different versions of products of the user selected product type; (4) enables the user to sequentially pick one of the displayed product images of the products from each set of comparative displayed product images to step by step narrow the scope of the desired product or to define the preferred characteristics of the product; (5) uses data associated with the picked product images to eventually select a specific product with some or all of the desired or preferred characteristics that the user is looking for; and (6) enables the user to purchase the selected product or facilitates the purchase of the selected product.

It should be appreciated that the product comparison and selection system disclosed herein is configured to assist: (1) a user that is looking for ideas of a product type to buy but has no specific parameters of the specific product of that product type they are looking for; (2) a user that has very specific parameters of the product they are looking for; or (3) a user that is anywhere in between. The users of the system can be individuals that are acting on their own behalf or can be individuals that are acting on the behalf of a third party or entity such as a business.

The term “product category” is generally used herein to refer to a category of products. For example, jewelry is an example product category. Examples of other product categories include accessories, women's clothing, floor coverings, appliances, and furniture.

The term “product type” is generally used herein to refer to type of product. For example, wedding dresses and watches are each example product types.

The term “product” or “specific product” are generally used herein to refer to a specific product. For example, a leather banded gold watch with roman numerals is a specific product. A product can generally include any tangible thing or item. In should also be appreciated that in alternative embodiments, the products can include services.

The term “characteristic(s)” or “product characteristic(s)” are generally used herein to refer to the characteristics, attributes, features, or functions of a product or product type.

The term “desired product profile” is generally used herein to refer to the group of the user's desired product characteristics of the product type which have been determined by the system from the user directly inputting preferred product characteristics and/or from the user picking preferred product images from the sets of comparative product images of different products of the product type.

The more specific descriptions of various embodiments of the system set forth herein sometimes use one or more example product categories, product types, and specific products. It should be appreciated that these examples are not meant to limit the scope of the present disclosure.

### I. Product Data Collection, Organization, Processing, and Storage

Each implementation of the product comparison and selection system of the present disclosure includes any suitable number of product categories and any suitable number of product types in each category. Generally, in various embodiments, for each product type that the system will sequentially enable a user to select, the system: (1) obtains or collects certain data for the visual product images and related information for different specific products of that product type from any one or more suitable product providers (which includes for purposes of this application product information sources): (2) organizes and/or processes the data of the visual product images and related information for each specific product; and (3) stores the organized and/or processed data of the visual product images and related information for each product. For purposes of this application, such visual product images and related product information and data will sometimes be referred to herein as product data. The system uses the obtained or collected product data to create a product information database for each product type and stores this data and information in one or more memory devices.

The visual product images can be any suitable types of images such as, but not limited to, photographs of the products or graphical images (e.g., sketches, drawings, etc.) of the products. For brevity, the visual product images are sometimes referred to herein as product images or simply images. It should be appreciated that the system can store or access the visual product images and related product data used by the system in any suitable manner.

The system obtains the product images from any suitable product provider (such as a product information source, product seller, product retailer, product wholesaler, product distributor, or product manufacturer). It is anticipated that the operator or implementer of the system will enter into agreements with such product providers whereby the product providers provide product data (including product images) to the system. It should be appreciated that certain of these agreements will require the product provider to pay the system operator advertising or other fees for using the product provider's product images in the sets of displayed comparative product images or otherwise. It should further be appreciated that any suitable payment arrangement may be employed in accordance with the present disclosure.

In various embodiments, the system obtains, collects, organizes, and/or processes, and stores product data for each of the types of products (that the system will enable the user to select) before enabling the user to select any product types. The system stores a list of the different available product types. The system uses this list to enable the user to select the product type that the user is interested in as further discussed below. In certain embodiments, the system also organizes the product types into product categories and stores a list of the different available product categories. In certain embodiments, the system uses this list to enable the user to select the product category before selecting the product type as further discussed below.

As mentioned above, the system stores the obtained, collected, organized, and/or processed product data in one or more suitable databases. For each product type, the system stores various suitable data or information regarding the product type and each of a plurality of different specific products of that product type. For example, if the product type is watches, the system stores certain information or data regarding the product type of watches and the system stores certain information or data regarding each of a plurality of different watches that the system can display to the user using the product images of the product data.

The obtained and stored product data for each product type may include, but is not limited to, any suitable combination of the following: (a) a name of the product type or other suitable identifier; (b) a product type identifier or identification number; (c) a list of different characteristics of the product type; (d) a characteristic identifier or identification number for each different characteristic of the product type; (e) groups of characteristics; (f) the product category in which the product is in; and (g) a product category identification number. It should be appreciated that the product type data collected, stored and/or used by the system for each product can vary in accordance with the present disclosure.

The obtained and stored product data for each specific product may include, but is not limited to, any suitable combination of the following: (a) the name of the product; (b) a product identifier or identification number; (c) a list of different characteristics of the product; (d) an characteristic identifier or identification number for each specific different characteristic of the product; (e) product image data; (f) a product image data identifier or identification number; (g) the product provider; (h) a price for the product; (i) a uniform resource identifier of the product provider for the specific product; (j) the product category in which the specific product is in; (k) a product category identification number; (l) the product type in which the specific product is in; and (m) a product type identification number. It should be appreciated that the specific product data collected, stored and/or used by the system for each specific product can vary in accordance with the present disclosure.

It should be appreciated that a product may have a relatively small, relatively medium, or relatively large quantity of characteristics and that each different product may have a different quantity of characteristics. For each product, the system is configured to capture product data including some, most, or all of these characteristics. In other words, the present disclosure contemplates that different product types will have different quantities of characteristics and that the system can be configured to account for this in accordance with the present disclosure.

In various preferred embodiments, the system captures the important, significant, or major characteristics. It should be appreciated that each product type may have one or different types of characteristics such as one or more major characteristics and/or one or more minor characteristics. In certain embodiments, the system focuses on determining the user's preferences for the major characteristics for the product type. In other embodiments, the system focuses on determining the user's preferences for the major characteristics and the minor characteristics for the product type. In other embodiments, where the user knows (and inputs) the user's preferences for the major characteristics for the desired product, the system focuses on determining the user's preferences for the minor characteristics for the product type. It should thus be appreciated that the present disclosure contemplates that the system can utilize any suitable characteristics for each product.

In various embodiments, the system is configured to process product data received from a product provider in different suitable manners. In one embodiment, the system will receive product data for each specific product, and suitably process and categorize such product data. For example, in one embodiment, for product data associated with a specific watch received by the system, the system identifies the product type and each of the different relevant product characteristics of the watch. More specifically, using this watch example, in addition to the above information for each specified product, the system captures characteristics such as: (1) the type of band (e.g., material, leather, or metal); (2) the color of the face; (3) numerals or no numerals; (4) the type of numerals (e.g., Arial or roman); and (5) digital or analog.

Capturing and storing this type of product data for each product provides the system part of the data that facilitates the system's ability to directly or inferentially figure out the user's preferences for the product type when the user selects the user's preferred product from each of the sets of displayed comparative product images as further discussed below. Capturing and storing this type of data for each product also enables the system to enable the user to directly input preferred characteristics and use those inputs in selecting the sets of comparative product images to display to the user. It should be appreciated that as the user makes inputs, in certain embodiments, the system will organize, process and store data based on those user inputs. Thus, as further described below, in certain embodiments, when the system is selecting the sets of comparative product images to display to the user, the system uses the stored product data to select the appropriate product images, and also uses data based on previous inputs from the user.

It should be appreciated that each different implementation of the product comparison and selection system of the present disclosure will obtain, collect, process, organize, and store the product data based on how that implementation of the system will use that product data and inputs by the user.

As further discussed below, in various embodiments, the system is configured to display sets of comparative product images where the different characteristics of the products are clearly discernable to the user, and/or alternatively is configured to display sets of comparative product images where the different characteristics of the products are less discernable to the user. In certain embodiments, the system displays one or more additional indications of the different specific characteristic of the displayed sets of comparative product images that the system wants the user to focus on for picking. In certain embodiments, the system displays additional indications of the several different characteristics of the displayed sets of comparative product images that the user can focus on for picking. Thus, it should be appreciated that for each set of comparative product images displayed to the user, the system can: (a) not focus the user at all on any specific characteristic; (b) focus the user on a limited number of characteristics; or (c) focus the user on several characteristics.

Each implementation of the system can start out with any suitable number of product categories or product types. It should be appreciated that if the implementation of the system starts out with relatively few product categories or product types, the system can grow by adding additional product categories and/or product types.

In this regard, it should be appreciated that a system implementation in accordance with the present disclosure can be limited to certain product categories or product types. The product categories can be any suitable types of product categories. For example, one implementation of the system can be for the product category of sporting goods, another implementation of the system can be for the product category of men's clothing, another implementation of the system can be for the product category of women's clothing, and another implementation of the system can be for product category of consumer products which includes all of these three product categories. Each of the product categories can include one or multiple different product types, and each product type will include multiple different specific products of that product type.

In various embodiments, as mentioned above, the system obtains the product type data and specific product data from one or more product providers (such as one or more retailer systems) which sell that type of product. In various embodiments, the system processes, organizes and stores the user inputs based on the displayed product images and uses this data to report back or provide feedback to the product providers (such as one or more retailer systems) regarding the products. This information can include, for example, the number of times a product (i.e., the product image) was: (1) displayed; (2) picked; (3) displayed against a specific different product; and (4) picked against that specific different product. It should be appreciated that the system operator will enter into suitable agreements to provide the product providers (such as one or more retailer systems) suitable data regarding their products. Such agreements can include any desired fees or payments to the system operator for such data.

It should further be appreciated that the system can categorize all of the products or product information of each product type in one user selectable group or can categorize the products or product information for a product type in two or more user selectable groups. The user selectable groups can be any suitable groups such as but not limited to: (1) territory of product provider; (2) price range of products of product type; (3) type of manufacturer (such as green or environmentally friendly manufacturers); and (4) what type of labor the manufacturer uses to make the product (e.g., no child labor). In various embodiments, the system provides the user an opportunity to select from one or more of such groups. In one example embodiment, the groups are various size territories such as: (a) global; (b) continent; (c) country; (d) region; (e) state; (f) county; and (i) city or town. In other words, the territories or geographic areas can include one or more countries, a single country, and a designated area in a country. These groups are employed by the system to assist in the searching for products of a product type. More specifically, if the user is in a rush to obtain a product, the user may want to search more locally for a product so that after selecting a product using the system, the user can quickly obtain the product. On the other hand, if the user is not in a rush to receive the product, the user may want to search more broadly for the product. This function can also be used by a user if the user desires to support local businesses. It should thus be appreciated that this function can be employed by the system in any suitable manner. In certain embodiments, the system can employ this function by enabling the user to enter in a mileage distance or mileage range from the user's location or from a designated location.

In alternative embodiments, instead of the system obtaining or collecting and organizing or processing the product data for use by the system, the system receives such already collected, organized, and/or processed product data from a product provider (such as a product seller) or other third party system. In such an embodiment, a list or set of product data requirements for the product data may be provided by the system operator, and the product data provided by the product provider (such as a product seller) or other third party system will be required to provide to the system in accordance with the set of product data requirements or structures.

In various alternative embodiments, instead of the system storing the product data for use by the system in the system's databases, a product provider (such as product seller) or third party system stores the product data in its databases, and the system accesses such product data databases in conjunction with use of the system by one or more users.

It should also be appreciated that the system of the present disclosure can alternatively be directly implemented by one or more product providers (such as product sellers, product retailers, product wholesalers, product distributors, or product manufacturers). In certain such embodiments, the system is incorporated into the product provider systems and the system directly uses at least part of the product data of the product provider systems, thereby somewhat reducing the product data collection steps. It should be appreciated that different product providers can implement the system differently.

It should be appreciated that in various embodiments, the system will employ one or more product or product image filtering systems or methods to avoid the duplication of the same products from different product providers (such as multiple retailers). It should also be appreciated that the system may be limited to one product provider (such as one retailer) for a product category or for a product type, and that such embodiments would more naturally limit duplication. In such embodiments, the system may employ different product providers for different product categories or product types. In an alternative embodiment, the system allows duplication of products or product images. In certain such embodiments, this enables the system to facilitate price comparison by the users for the same product from different product providers.

In the above described primary embodiments, the system obtains, collects, organizes, processes, and stores product data for each of the types of products (that the system will enable the user to select) before enabling the user to select any product types. In alternative embodiments, the system obtains product data for one or more types of products dynamically upon a user request to the system to assist the user in selecting a product of a product type.

### II. Initial User Product Category and Product Type Input or Selection

In certain embodiments, the system enables the user to initially select a product category for the product the user is looking for. This can be done by the system in a variety of different manners.

In one such embodiment, the system displays one or more lists of different product categories which are stored or accessible through the system, and which the user can select. In this embodiment, the system enables the user to select one of the product categories on the list. After the user selects one of the product categories on the list, the system proceeds to enable the user to select a product type in such selected product category as further discussed below.

In another embodiment, the system enables the user to enter (such as by typing in) the name of a product category for the product the user is looking for. If the system does not store or is not configured to handle that product category, the system provides a suitable message to the user. If the system stores or is configured to handle that product category, the system proceeds to enable the user to select a product type in such selected product category as further discussed below.

In another embodiment which combines these two above alternatives, the system enables the user to either: (a) select from a displayed list of available product categories, or (b) type in the name of the product category the user is looking for. If the user selects one of the product categories on the displayed list, the system enables the user to select a product type in such selected product category as further discussed below. If the user enters the name of a product category that the system does not store or is not configured to handle, the system provides a suitable message to the user. If the user enters the name of a product category that the system does store or is configured to handle, the system enables the user to select a product type in such selected product category as further discussed below.

It should be appreciated that the system can employ other suitable ways for the user to select or input the product category.

The system also enables the user to initially select a type of product or product type the user is looking for. This can be done by the system in a variety of different manners.

In one such embodiment, the system displays one or more lists of different product types which are stored or accessible through the system, and which the user can select. In this embodiment, the system only enables the user to select one of the product types on the list. After the user selects one of the product types on the list, the system then proceeds to cause the sequential display of sets of products of the selected product type as further discussed below.

In another embodiment, the system enables the user to enter (such as by typing in) the name of product type the user is looking for. If the system does not store or is not configured to handle that product type, the system provides a suitable message to the user. If the system stores or is configured to handle that product type, the system then proceeds to the sequential display of sets of products of the selected product type as further discussed below.

In another embodiment which combines these two above alternatives, the system enables the user to either: (a) select from a displayed list of available product types, or (b) type in the name of the product type the user is looking for. If the user selects one of the product types on the displayed list, the system then proceeds to the sequential display of sets of products of the selected product type as further discussed below. If the user enters the name of a product type that the system does not store or is not configured to handle, the system provides a suitable message to the user, If the user enters the name of a product type that the system does store or is configured to handle, the system then proceeds to the sequential display of sets of products of the user inputted product type as further discussed below.

It should be appreciated that the system can employ other suitable ways for the user to select or input the product type.

In the above example embodiments, the system only enables the user to search for product types which the system has previously identified and cataloged as generally described above. In other embodiments, if the user inputs a product type that the system has not cataloged, the system dynamically creates the catalog of the product data for the visual images and related product characteristic information for that product type from suitable product providers such as product information sources or one or more retailer systems (as generally discussed above).

It should also be appreciated from the above that in various embodiments, after the user selects one of the product categories and/or one of the product types, the user access device sends data representing the user selections to the servers controlling or providing the system web site.

### III. Selection and Sequential Display of Sets of Comparative Visual Product Images of the User Selected Product Type

After the user has inputted or selected a product category and a product type the user is searching for, in various embodiments, the system: (1) determines from the databases the sets of specific products of that product type to sequentially display to the user, and specifically sets of comparative product images of different versions of the product of the user selected product type; and (2) sequentially displays to the user the determined sets of comparative product images of different versions of the product of the user selected product type. It should be appreciated that for each product type, the system may predetermine or partially predetermine the sets of comparative product images for that product type before the user selects the product type.

As mentioned above, the sets of comparative product images to display to the user are selected by the system based in part on how the system has organized the product data and based on how the system will use the user inputs (i.e., the selection of one of the displayed images of products in each set) to determine the user's preferences for certain characteristics of the product type.

The sets of comparative product images are thus selected and arranged to be displayed by the system to directly or inferentially determine certain characteristics of the product of the selected product type which are preferred by the user to eventually determine the user's desired product profile.

After the product type is selected, in one embodiment, the system selects all of the sets of product images of the selected product type to display to the user before the system enables the user to select from any of the displayed sets of product images.

In another embodiment, the system, one at a time selects and displays sets of comparative product images of the selected product type to the user. In this embodiment, the system uses the data related to the product image picked by the user in each set for the system to subsequently pick the product images for display in one or more subsequent sets of comparative product images.

In this embodiment where the system does not select all of the sets of comparative product images until the user starts to pick product images from the displayed product images, the system selects the subsequent sets of product images using data related to one or more of the product images picked by the user. In other words, the system can keep one or more of the user picked displayed product images to form one or more of the subsequent displayed sets of product images. For example, if the first set of displayed product images includes Product Image 1 and Product Image 2, if the user picks Product Image 2, then for the second set of displayed product images, the system can select and display Product Image 2 and Product Image 3. Continuing with this example, if the user then again picks Product Image 2, then for the third set of displayed product images, the system can select and display Product Image 2 and Product Image 4. Continuing with this example, if the user then picks Product Image 4, then for the fourth set of displayed product images, the system can select and display Product Image 4 and Product Image 5.

In a further alternative embodiment, the system mixes both of these approaches by: (a) for a first group of the sets of product images, pre-selecting the product images of each set; and (b) for a second group of the sets of product images, picking the product images of each set after the user has picked product images from one or more previously displayed sets.

In one embodiment, in each set, the system displays two different product images of two different products of the product type the user is looking for. In other embodiments, in one or more of the sets, the system displays more than two different product images of different products of the product type the user is looking for.

It should be appreciated that the sets of comparative product images can be grouped in a variety of different suitable manners. In one embodiment, the sets of comparative product images are grouped by product characteristics. Using the watch example, the sets of comparative product images are organized in a group for the band and a group for the watch face.

For each set of displayed product images, the system will select and display product images of the products of the selected product type that have one or more different characteristics. In the simplest form, for a set of displayed product images, the system selects and sequentially displays product images of the products of the selected product type that have only one different characteristic. For example, the system displays two images of the same watch with different bands. In this case, it is relatively easy for the system to determine based on the displayed product image, the preference of the user in relation to that different characteristic after the user picks one of the product images of that set. Using this simplest form, if a product has a designated quantity (such as ten) of major characteristics, the system can select and sequentially display product images of similar sets of products where the only difference in each set is one of the designated major characteristics of the product type. In one such embodiment, for each set, everything else for the displayed products except that characteristic is the same. In this case, after the designated quantity of comparative sets of displayed product images are displayed to the user and the user picks one of the product images from each displayed comparative sets of product images, the system determines or has determined that the user desires a product with the designated quantity of characteristics associated with the picked product images. The system can then find a specific product in the system database which has those characteristics or alternatively as many of those characteristics as possible and present or display that product to the user for purchase.

As mentioned above, it should also be appreciated that the displayed product images can have easily distinguishable different characteristics or can have less distinguishable different characteristics.

The present disclosure thus contemplates more complex forms of sets of product images for the system to select and display. For a set of displayed product images, if the system selects and display product images of the products of the selected product type that have multiple different characteristics, it is relatively more complex for the system to determine based only on that set of selected displayed images, the preferences of the user for each of the characteristics. It should thus be appreciated that the number of different ways to implement the selection of products images which form the sets of comparative product images to determine the characteristic(s) of the selected product type that the user prefers is practically endless. The present disclosure contemplates that each specific system implementation will have one or more specific methods of selecting the sets of product images based on the product data and for determining directly or inferentially from the user's picks of the product images from each of those sets part of the desired product profile of the user. It should be appreciated that the present disclosure contemplates that many different suitable algorithms can be used in this process.

In one relatively complex embodiment, the system mixes and matches product images in the sets of comparative images to determine the user preferences. For example, in one embodiment, the system displays multiple sets of product images to determine one preferred characteristic. In another example embodiment, the system displays multiple sets of product images to determine multiple preferred characteristics, and determines these preferred characteristics based on a suitable algorithm linked to the coding of the characteristics of each of the displayed product images.

In one embodiment, the system displays each of the product images without any text or additional information regarding each of the products of the selected product type displayed in the product images. In this embodiment, the user must pick one of the displayed product images (i.e., one of the displayed products) without any additional information about those displayed products.

In another embodiment, the system displays each of the product images with text or additional information regarding one or each of the products displayed in the product images. In this embodiment, the user must pick one of the displayed product images (i.e., one of the displayed products) based on the displayed product images and the additional information about those displayed products.

In another embodiment, the system displays each of the images without any text or additional information regarding each of the products displayed in the product images, but enables the user to obtain more information about one or more of the displayed product images (i.e., one of the displayed products) such as by asking for more information or clicking on a more information button displayed by the system before picking one of the product images.

In another embodiment, the system displays each of the product images with text or additional information regarding one or each of the products displayed in the product images and also enables the user to obtain more information about one or more of the displayed product images (i.e., one of the displayed products) such as by asking for more information or clicking on a more information button displayed by the system before picking one of the product images.

It should be appreciated that the system can display each of the sets of product images in a variety of different manners such as side by side, or one above the other. It should also be appreciated that in various embodiments, the quantity of displayed comparative product images in each set is limited such as limited to: (a) only 2 product images; (h) only 3 product images; (c) only 4 product images; and (d) only 5 product images. Limiting the quantity of displayed product images in each set make the user's choices simple.

In various embodiments, (a) the system enables the user to directly input or select (i.e., pre-select) one or more of the user's preferred characteristics for the product type before the system starts to display any of the sets of comparative product images for that product type; (2) the system enables the user to directly input or select one or more of user's preferred characteristics for the product type after the system starts to display one or more sets of comparative product images for that product type; or (3) do both of these. In these embodiments, the system is enabling the user to at least partially directly build the user's desired product profile and the system in certain embodiments selects and displays sets of comparative product images of the product type based on these user inputted preferred characteristics. In certain embodiments, the system operates as if these user preferred characteristics are determined by the system from the user's picks. It should also be appreciated that the system can determine that the user has directly inputted enough characteristics to skip part or all of the display of the sets of comparative product images and move to the system finding a specific product of the product type which meets the user's desired product profile and then enable the user to buy that specific product or similar products. Thus, it should be appreciated that in certain embodiments, this feature enables the system to meet the needs of different users or users that have different levels of knowledge of the product characteristics they prefer for a product type.

It should further be appreciated that the system in certain embodiments builds and stores user profiles for users such as users who become members of the system or a club of the operator of the system. In certain embodiments, the system employs the user profile information to select one or more of the sets of comparative product images of the product type. For example, if the user profile indicates that the user prefers the color white, when selecting product images from the system's database of product images for a product type, the system would select product images which include white products. In further embodiments, the user profiles include substantially more complex user profile information and the system uses that information when performing system functions. In certain embodiments, the system determines a user's profile inferentially based on the user's use of the system in one or more previous product searches, or directly based on information provided by the user, or both in various different embodiments.

### IV. Sequential User Picking of Displayed Product Images

The system will enable the user to sequentially pick one of the displayed product images (Le., one of the different versions of the product) from each set of displayed product images step by step to narrow the scope of the desired product profile or characteristics or to determine the user preferred characteristics for the product type. The present disclosure contemplates that this can be done in several different ways.

In one embodiment, after each set of comparative product images are displayed, the system simply enables the user to input a pick of the preferred product image using an input device (such as a touch screen) of the user access device.

In certain embodiments, in addition to enabling the user to pick images, the system enables the user to select one or more of the displayed product images (or products) to be grouped in a favorite category for that product type. This feature enables the user to collect favorite product images (or products) as the user is picking product images from the sets of comparative product images. In one embodiment, the system displays the favorites as the user collects them. In another embodiment, the system displays the favorites upon a request inputted by the user. In certain embodiments, the system also enables the user to recall one or more of the user's favorites and to find out more information on, purchase or be directed to a product provider where the user can find out more information on or purchase one of the user's favorites. In one embodiment, the system limits the quantity of favorites that the user can collect as the user is viewing the sets of comparative product images. In another embodiment, the system does not limit the quantity of favorites that the user can collect as the user is viewing the sets of comparative product images.

It should also be appreciated from the above that in various embodiments, after the user selects one of the displayed comparative product images of each set of displayed comparative product images, the user access device sends data representing the user selection to the servers controlling or providing the system web site.

### V. System Use and Determinations Based on User Picked Displayed Product Images

The system uses the product images picked by the user from each set of comparative product images, and more specifically the product data associated with the product images picked by the user to determine a desired product profile and one or more specific products with the user desired characteristics or desired product profile that the user is looking for based on the user's sequential picks of the displayed product images. The present disclosure contemplates that this can be done in a variety of different suitable manners directly and/or inferentially.

In one embodiment, after the user has picked each of the preferred product images from the sets of comparative images, the system determines the user's preferred characteristics for the desired product of the selected product type.

In one embodiment, as the user is selecting product images and thus preferences of the characteristics of the desired product of the selected product type, the system does not provide the user any information on what the system has determined to be the user's preferences.

In another embodiment, as the user is selecting product images and thus preferences of the characteristics of the desired product of the selected product type, the system provides the user certain information on what the system has determined to be the user's preferences. The system can display this information in a variety of different suitable manners. In one example, the system displays a list or checklist of major (and/or minor) characteristics and indicates to the user after each characteristic is determined.

It should be appreciated that as explained above, that in certain embodiments, the system enables the user to pre-select or select before or during the sequential display of the product images of the sets of comparative product images, certain preferences for characteristics of the selected product type to short cut or speed up the preferred characteristic selection process through the display of the sequential sets of comparative product images.

In various embodiments, the system will employ appropriate coding for or associated with each product image and the characteristics of the product of that product image. The system will base its determination of the user preferred characteristics on this coding and on suitable algorithms which are based on this coding. It should be appreciated that the system, after determining the desired product profile, can provide or display to the user suggested products for purchase in a variety of different manners such as in the examples set forth herein.

The present disclosure further contemplates that in various embodiments the system has one or more different operating modes. In various embodiments, the system is configured to operate in: (a) a “compare” mode after the product type is selected; and (b) a “similar” mode after the product type is selected and after a designated quantity of the characteristics of the product type are determined (i.e., after part of the desired product profile is determined). More specifically, in the compare mode, the system is selecting and displaying comparative sets of product images to determine the user's preferred characteristics. In the similar mode, the system is selecting and displaying comparative sets of product images that have the designated characteristics directly or inferentially determined by the system from the user inputs. These user inputs can be direct inputs of desired or preferred characteristics by the user or user picking of product images and the system determining based on these picks the desired or preferred characteristics. It should be appreciated that in various embodiments the system has multiple similar modes.

In various embodiments, the system: (1) automatically switches from a compare mode to a similar mode when a designated quantity of the characteristics of the product type are determined by the system; (2) enables the user to switch the system from a compare mode to a similar mode; or (3) automatically switches from a compare mode to a similar mode when a designated quantity of the characteristics of the product type are determined by the system, and also enables the user to switch the system from a compare mode to a similar mode. In one embodiment, the system does not notify the user when the user switches modes. In another embodiment, the system notifies the user that the system is switching modes. In another embodiment, the system notifies the user and confirms with the user one or more of the preferred user characteristics that the system has determined.

In one example discussed below, the notification to the user is referred to as a trend alert that the system provides to or displays to the user. These alerts provide the user information about what the system has directly or inferentially determined (from the user's picks of the product images) to be one or more of the user's preferences on certain of the characteristics for the selected product type. It should be appreciated that in certain embodiments the system provides the user multiple trend alerts and can enable the user to agree with or approve the selected characteristics of the trend alert or reject one or more of those characteristics. In one embodiment, when the user approves the selected characteristics or the trend alert, the system switches to the similar mode and subsequently selects for display sets of comparative product images where the products in those images have the determined user preferred characteristics or meets the desired product profile determined by the system at that point in the process, It should also be appreciated that the trend alerts could also be in part based on user inputted desired characteristics.

### VI. Purchase of Selected Product or Product with the Selected Product Profile

The present disclosure contemplates that once selected, the selected product can be purchased in any one of a plurality of different ways.

In one embodiment, the system directly enables the user to purchase the selected product through the product selection system (i.e., the pages or user interfaces of or provided by the system).

In another embodiment, the system facilitates the user's purchase of the selected product such as by directing the user to a product provider (such a retailer system) which enables the user to directly purchase the selected product with the desired product profile and the system simply acts as a facilitator to direct the user to such product provider.

In alternative embodiments, after the product selection system determines the desired characteristics of the product in the selected product type or the desired product profile, the system determines from its databases one or more specific products that fit or that most closely fit that desired product profile. The system then connects or directs the user access device to the product provider system for that specific product. Alternatively, the system can provide one or more links to such product provider systems.

### VII. Additional User Control, User Functionality and User Features

The present disclosure also contemplates that the system can provide the user one or more additional suitable controls or functions in the operation of the system.

In one example embodiment, prior to the sequential display of the sets of comparative product images, as mentioned above the system enables the user to directly select one or more of the users' preferences of the characteristics of the selected product type to increase efficiently. This feature enables a user who has a partially or totally defined product of the selected product type to input this information into the system. The system can, for example, enable this by listing each of designated set of characteristics of the product. Using the watch example, if the user knows that the user wants a leather band, a face with a gold outer rim, and roman numerals, the system enables the user to directly input or select these characteristics. The system then selects sets of comparative product images of different watches to display which each have these user selected characteristics to assist the user in selecting additional characteristics and one or more specific products that have these user selected characteristics.

In another example embodiment, the system enables the user to stop the search process if the user sees in one of the product images the product the user desires to purchase.

### VIII. Additional Functionality and Features

The present disclosure further contemplates that the system of the present disclosure can employ one or more additional functions for the operation of the system. The following is a brief explanation of examples of certain of these functions or these additional functions themselves.

In various embodiments, the system web pages includes one or more sections (such as the section on the right hand side of the displayed page) at various times or at all times for different product providers to advertise in association with a particular product type. For example, a company that sells jewelry may opt to advertise on the right hand side when a customer is searching under the “NECKLACES” product type (rather than pay to put product images of its necklaces in the sets of comparative product images). It should be appreciated that any product provider may advertise in this section of the system web pages or interfaces. It should also be appreciated that the system may limit these advertisements based on inputs by the user such as when the user picks a group limitation (such as global, country or local).

In certain embodiments, the product selection system of the present disclosure does not provide the user any coupons or discounts or otherwise depend on the price of the products, but rather simply assists the user in selecting a specific product of a product type. In various embodiments, the product selection system assists the user in selecting a specific product that is in the user's picked or inputted acceptable price range (because picking a product outside of the user's prices range often does not substantially assist the user). In other embodiments, the system associates coupons or discounts with the products for the users.

In certain embodiments, the system enables the user to apply predetermined preferences against the system product databases to find a specific product. If the specific product does not exist in the system databases, the system enables the user to incrementally open the search by removing less prioritized preferences until the most specific product to the preferences is selected.

In addition to the system's functionalities for the user, as mentioned above the system is configured in certain embodiments to provide information back to the product providers such as the retailers. For each product image provided to the system by a product provider, the system can provide the product provider with statistics that will be tabulated on, for example, how many times the product image was displayed, how many times the product image was chosen as the favorite, in what location in the world the product image was shown and selected or not selected as a favorite, and how many times the product shown in that product image was purchased.

In certain embodiments, the system will also enable each product provider such as a retailer to have a ratings system where the user will rate and comment on the products and service of the retailer. In certain embodiments, the product providers such as the retailers will need to keep a certain level of ratings to keep their product images in use by the system. It should be appreciated that any suitable rating system may be employed in accordance with the present disclosure.

It should be appreciated, that in various embodiments, the system also enables the user to or automatically saves the users product search results for subsequent access and use by the user. It should also be appreciated that in various embodiments the system enables the user to print, and to send the user's search results (such as by email or text message).

Various of the above and additional features and advantages of various embodiments of the product comparison and selection system of the present disclosure will be further apparent from the following examples.

### IX. System Implementation Example 1

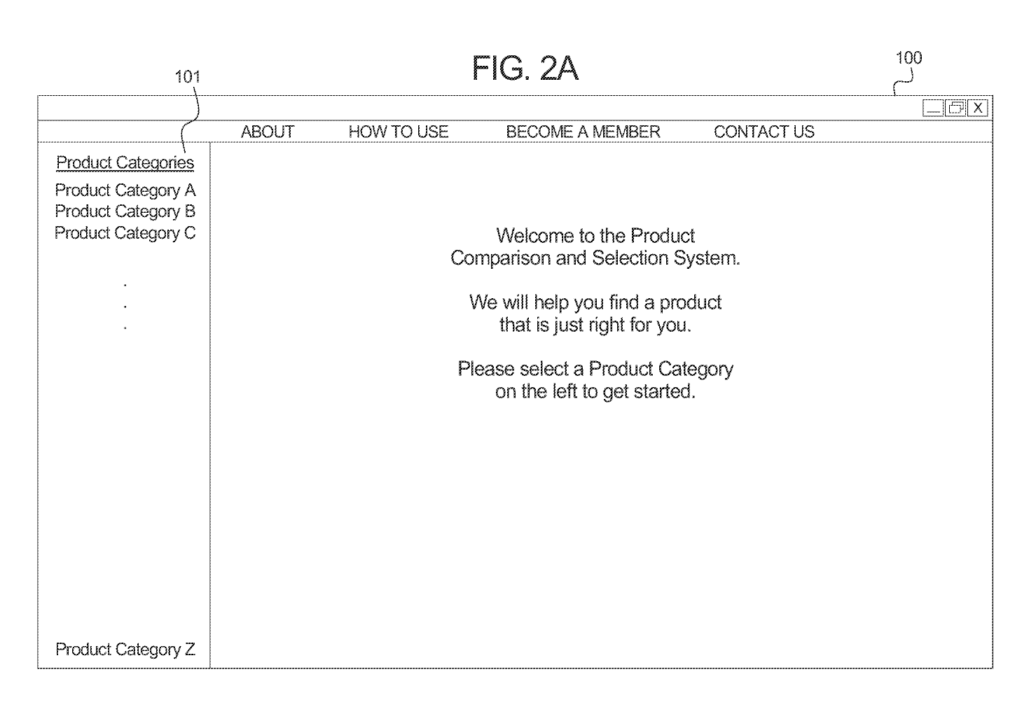

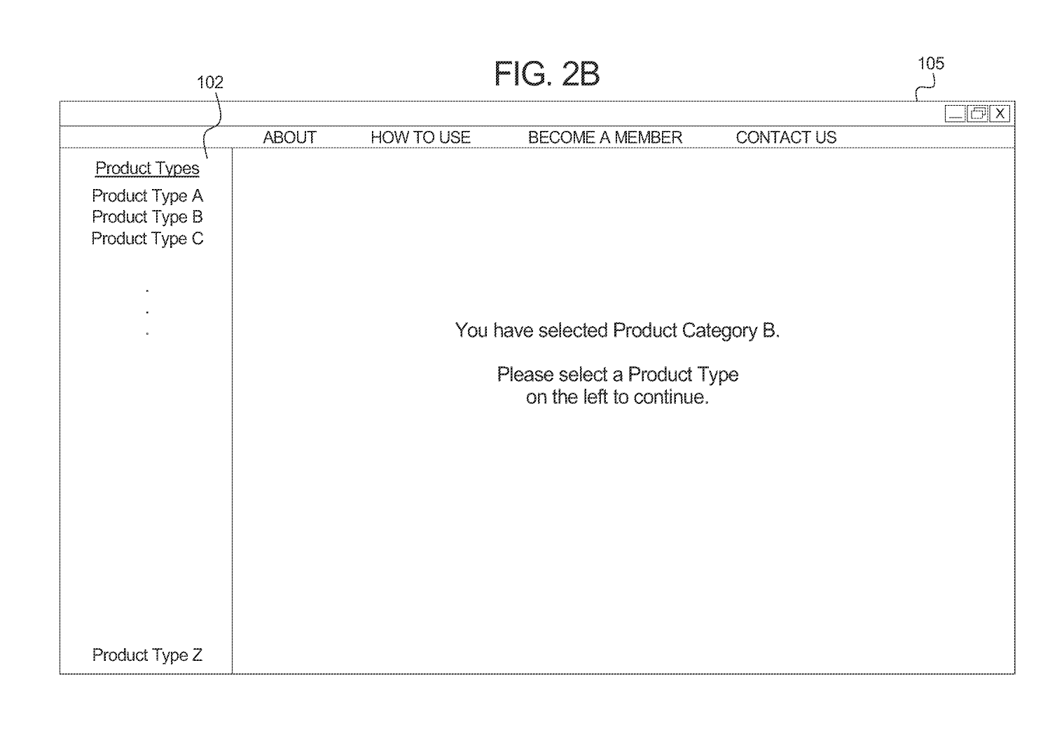

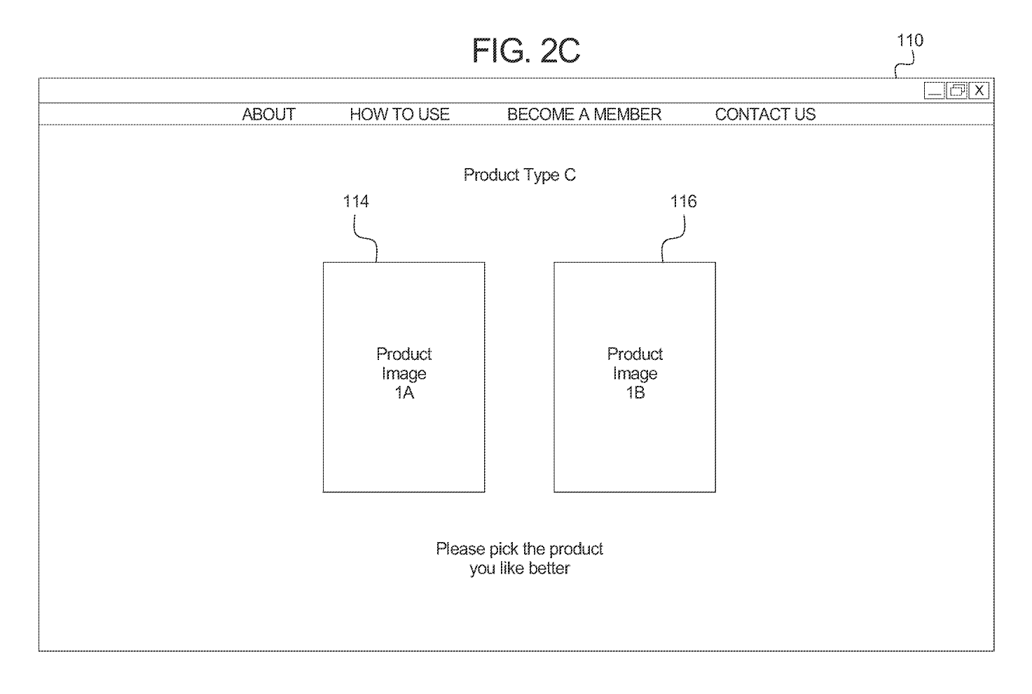

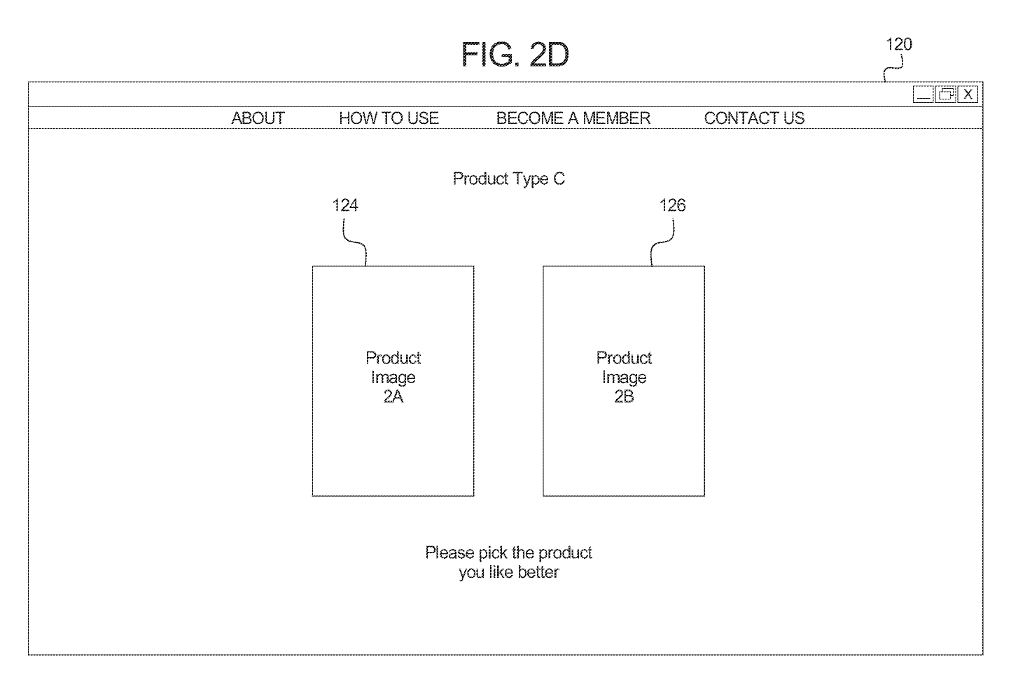

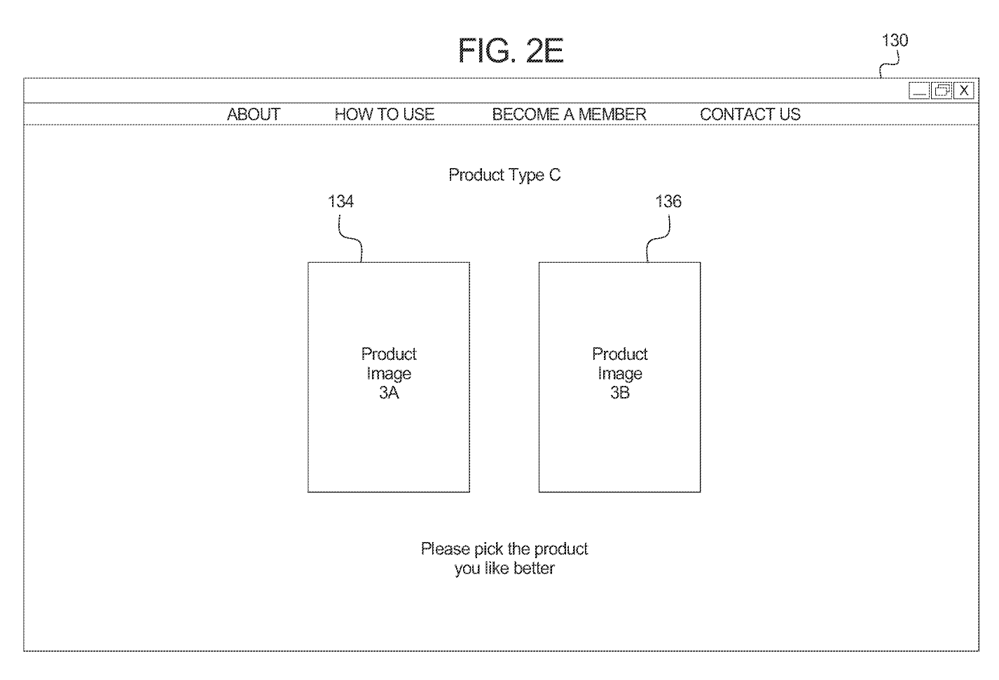

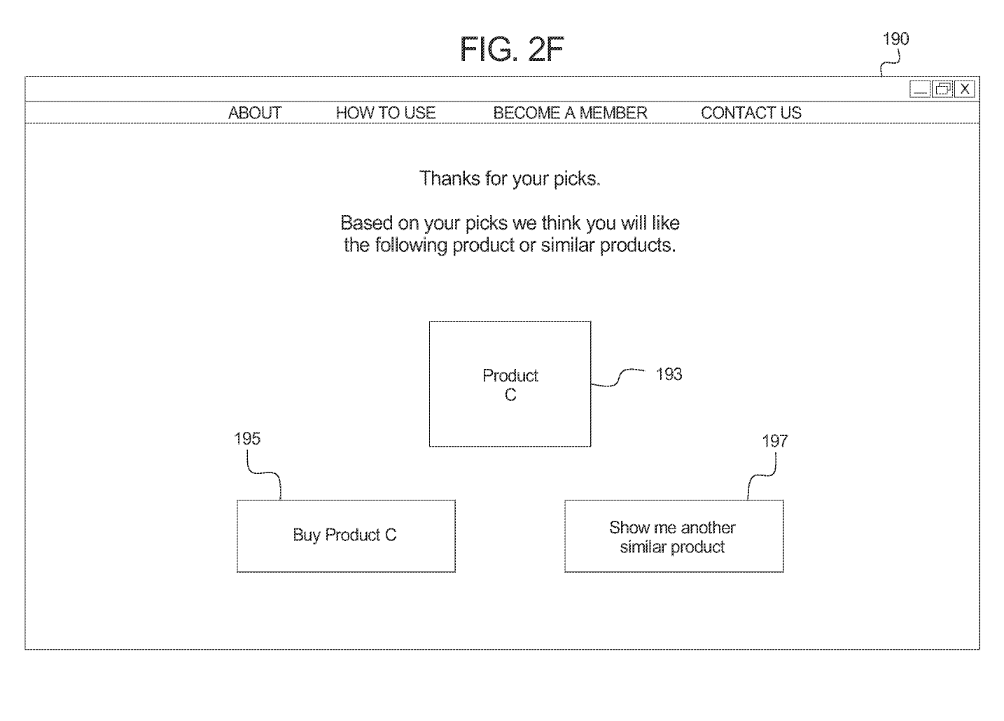

Turning now to FIGS. 2A, 2B, 2C, 2D, 2E, and 2F, the user interfaces of one example embodiment of the product comparison and selection system of the present disclosure are illustrated. This example embodiment demonstrates certain basic or fundamental functions or features of various embodiments of the system of the present disclosure; however, it should be appreciated that commercial implementations of the system of the present disclosure will likely include substantial additional functionality or features, and that these example interfaces are not being used to fully demonstrate a commercial embodiment of the system.

In this example, the user access device (not shown) enables the user to access the product comparison and selection system though a home page 100 as generally illustrated in FIG. 2A. After the user accesses the home page of the system, the system asks the user to and enables the user to select a product category from a list 101 of displayed different product categories (which are maintained by the system). As mentioned above, it should be appreciated that the system can display the list of product categories in any suitable manner and that the system can enable the user to pick one of the different product categories in any suitable manner.

It should be appreciated from FIG. 2A (and from various other figures) that the user interface or web page can include conventional web page tabs, buttons or links such as, but not limited to: (1) the about us link; (2) the how to use link; (3) the become a member link; and (4) the contact us link. These links direct the user to more functionality of the system which is of a conventional nature. It should be appreciated that the system of the present disclosure does not need to be employed with these functions. It should also be appreciated that the system can provide various other functions (such as but not limited to email or text features) and that when commercially implemented, the pages or interfaces will likely include the system operator name and logos.

After selecting the product category, the system asks the user to and enables the user to select a product type from a list 102 of displayed different product types (which are maintained by the system) as shown in the interface or page 105 of FIG. 2B. As mentioned above, it should be appreciated that the system can display the list of product types in any suitable manner and that the system can enable the user to pick one of the different product types in any suitable manner.

In this example, the user selects Product Type C. After the user picks one of the product types from the list of displayed different product types 102, the system causes the user access device to sequentially display to the user of a plurality of sets of comparative visual product images of different versions of the products of the user picked product type as generally illustrated in FIGS. 2C, 2D, and 2E. The system enables the user to sequentially pick one of the displayed visual product images of the products from each set of displayed visual comparative product images as also generally illustrated in FIGS. 2C, 2D, and 2E to step by step enable the system to determine the user preferred or desired product characteristics for the product type (i.e., the desired product profile).

More specifically, the system causes the user access device to display a product display page 110 which adjacently displays Product Image 1A labeled 114 and Product Image 1B labeled 116 as illustrated in FIG. 2C. The product of Product Image 1A is different from the product of Product Image 1B. The system also prompts the user to pick the product that the user likes better from the two displayed products such as by clicking on one of the displayed product images.

After the user picks one of the displayed product images, the system causes the user access device to display a product display web page 120 which adjacently displays Product Image 2A labeled 124 and Product Image 2B labeled 126 as illustrated in FIG. 2D. The product of Product Image 2A is different from the product of Product Image 2B. The system also prompts the user to pick the product that the user likes better from the two displayed products such as by clicking on one of the displayed product images.

After the user picks one of the displayed product images, the system causes the user access device to display a product display web page 130 which adjacently displays Product Image 3A labeled 134 and Product Image 3B labeled 136 as illustrated in FIG. 2E. The product of Product Image 3A is different from the product of Product Image 3B. The system also prompts the user to pick the product that the user likes better from the two displayed products such as by clicking on one of the displayed product images.

Although not shown, in this example, this process repeats for Product Image 4A and Product Image 4B, Product Image 5A and Product Image 5B, Product Image 6A and Product Image 6B, Product Image 7A and Product Image 7B, Product Image 8A and Product Image 8B, Product Image 9A and Product Image 9B, and Product Image 10A and Product Image 10B. As discussed above, it should be appreciated that the quantity of sets of comparative product images may vary in accordance with the system configurations and the product types. It should also be appreciated that certain of the product images may be used in more than one set of comparative product images as discussed above and further discussed below.

In this example embodiment, the system uses product data associated with the user picked product images to select a specific product with the user desired characteristics that the system has determined based on the picks by the user. In this example, as generally illustrated in FIG. 2F, the system causes the user access device to display a product search result web page 190 which displays a specific product (i.e., Product C) labeled 193 which the system determined to be a product which will be liked by the user based on the product images selected by the user, and thus the user desired product profile. It should of course be appreciated that this is a very simplistic example and that just picking a product based on the individual different characteristics may or may not result in a product desired by the user. In such case, the system can enable the user to request more sets of comparative product images, to start the search over again with different sets of product images, or can provide other suitable options. In this illustrated example embodiment, the system includes a show me another similar product button 197 which enables the user to direct the system to search for and display another similar product that the system thinks the user will like based on the user desired product profile.

In this illustrated embodiment, the system directly enables the user to purchase the selected product or facilitates the user's purchase of the selected product such as enabling the user to pick the Buy Product C button labeled 195 and when the user does so, by directing the user to a product provider system (such a retailer system) which enables the user to directly purchase the product with the desired product profile as generally illustrated in FIG. 2F. As mentioned above, the system could alternatively or additionally function to enable the user to purchase or find out more information regarding the product.

### X. System Implementation Example 2

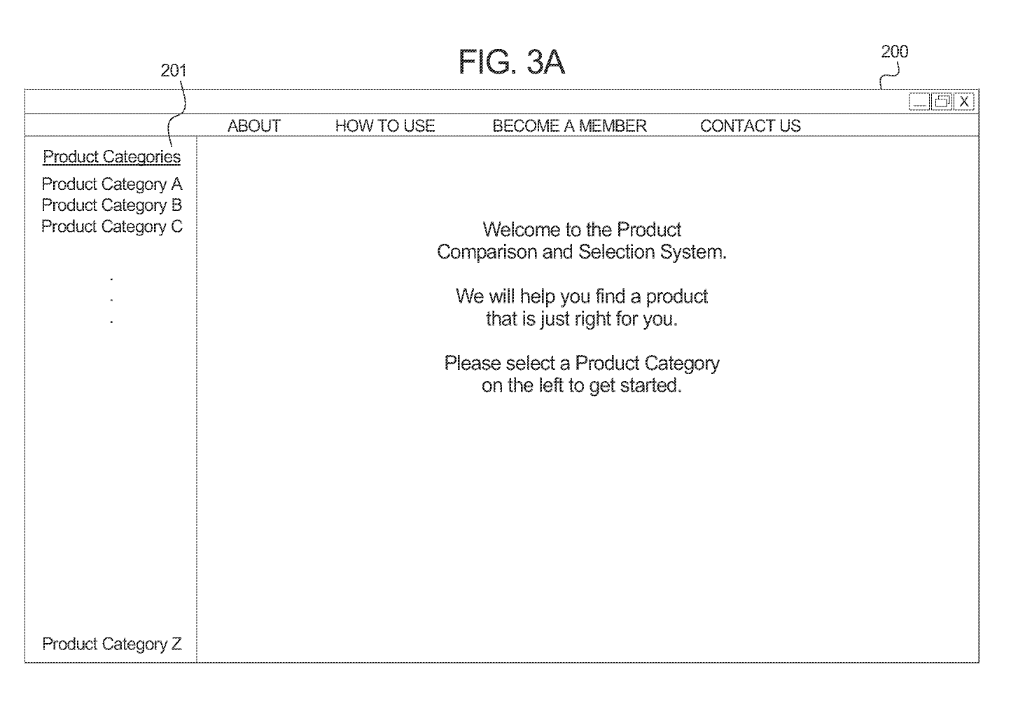

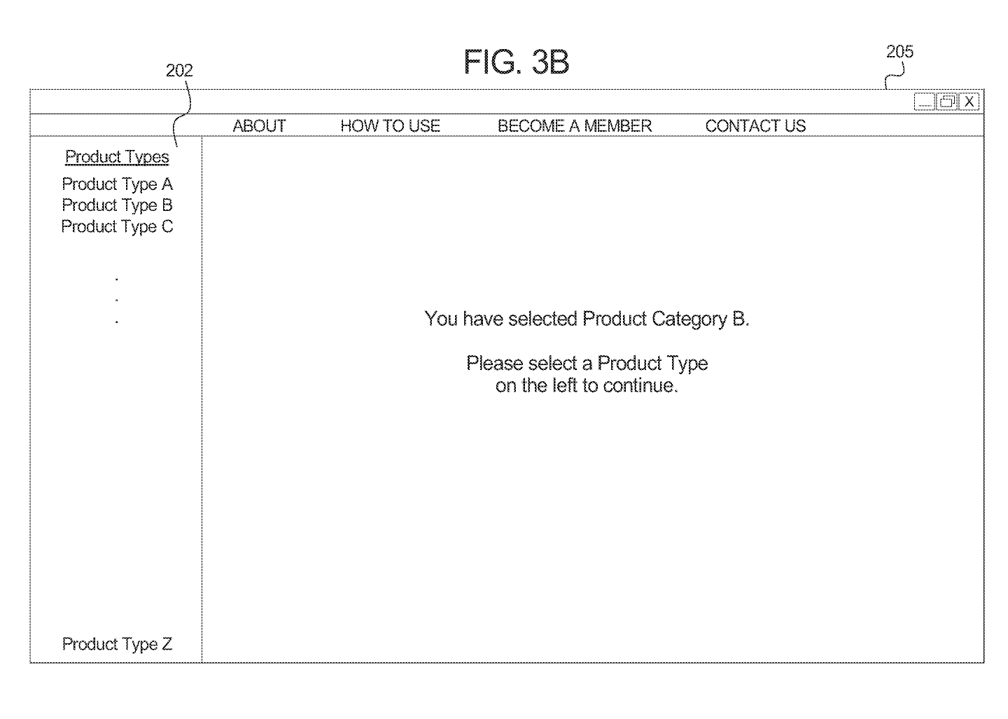

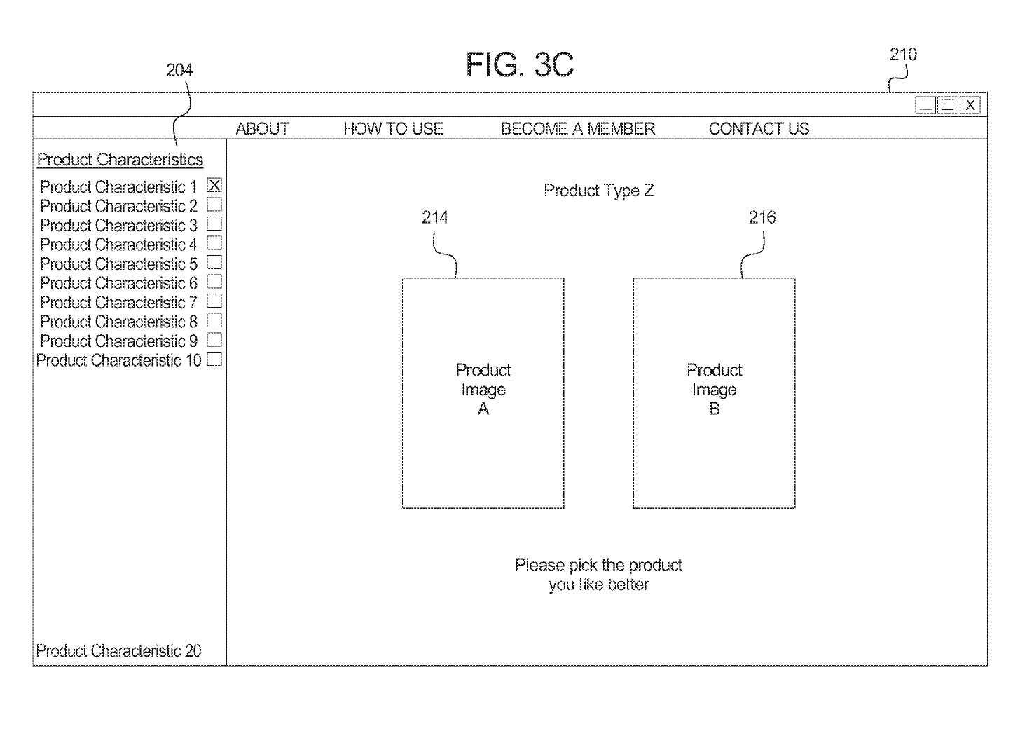

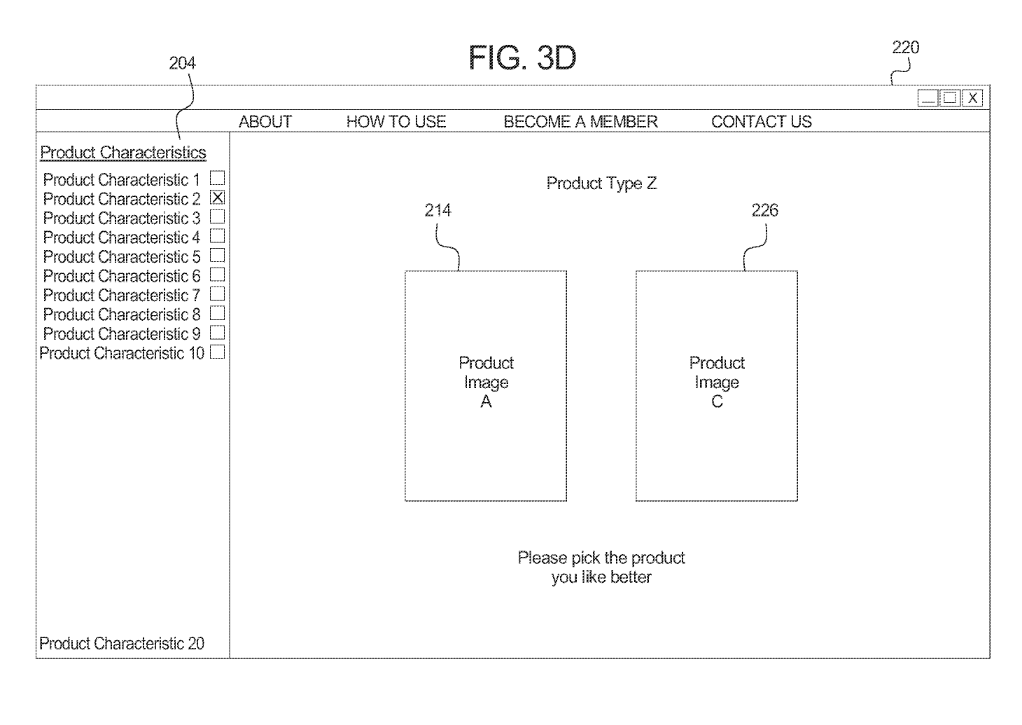

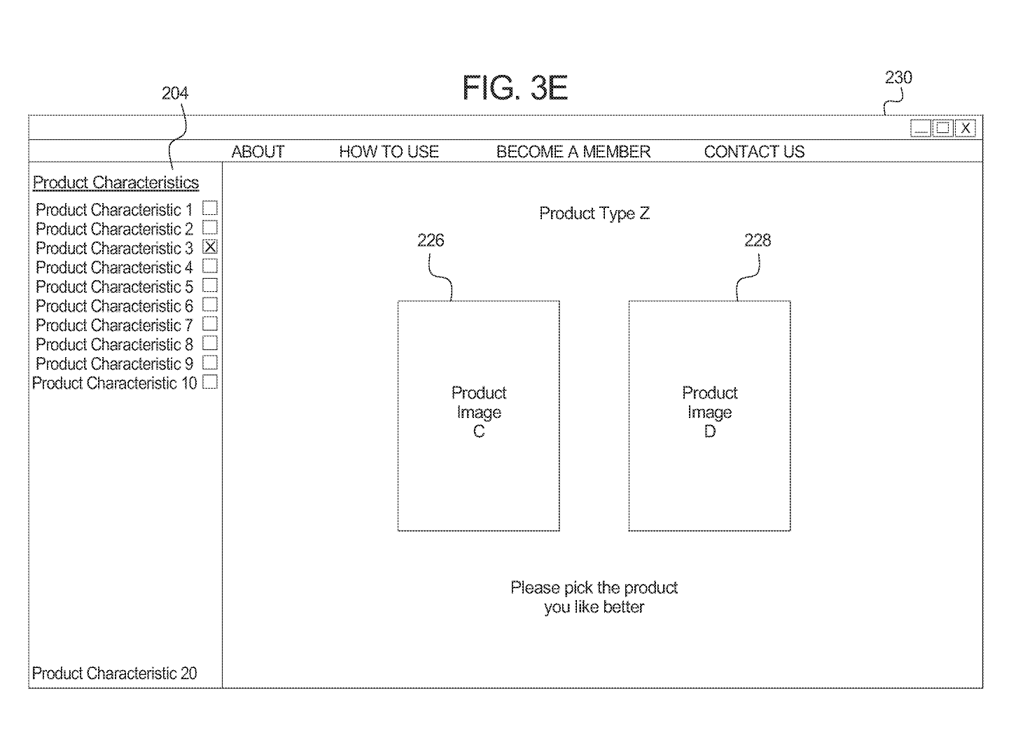

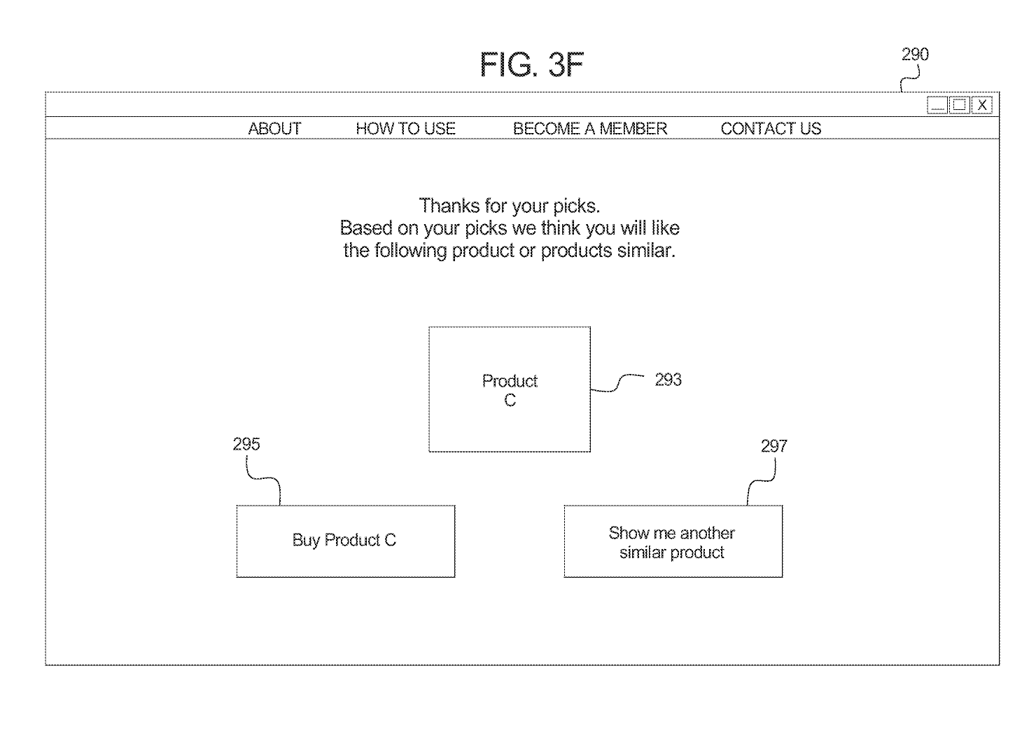

Turning now to FIGS. 3A, 3B, 3C, 3D, 3E, and 3F, the user interfaces of another example embodiment of the product comparison and selection system of the present disclosure are illustrated. Again, this example embodiment demonstrates certain additional basic or fundamental functions or features of various embodiments of the system of the present disclosure; however, it should be appreciated that commercial implementations of the system of the present disclosure will likely include substantial additional functionality or features, and that these example interfaces are not being used to fully demonstrate a commercial embodiment of the system.

In this example, the user access device (not shown) enables the user to access the product comparison and selection system though a home page 200 as generally illustrated in FIG. 3A. After the user accesses the home page of the system, the system asks the user to and enables the user to select a product category from a list 201 of displayed different product categories (which are maintained by the system). After the user selects a product category, the system asks the user to and enables the user to select a product type from a list 202 of displayed different product types (which are maintained by the system) as generally illustrated in the interface 205 of FIG. 3B.

After the user picks one of the product types from the list of displayed different product types 202, the system causes the user access device to sequentially display to the user of a plurality of sets of comparative visual product images of specific products of the user picked product type as generally illustrated in FIGS. 3C, 3D, and 3E. The system also enables the user to sequentially pick one of the displayed visual product images of the specific products from each set of displayed visual product images as also generally illustrated in FIGS. 3C, 3D, and 3E to step by step to enable the system to determine the user preferred or desired product characteristics for the product type (i.e., the desired product profile). In this example, after the first set of comparative product images, the system keeps the picked image from the previous set of product images for comparison to the next product image in the next set.

In this example, the system also indicates to the user certain information regarding various product characteristics of the selected product type. In FIGS. 3C, 3D, and 3E, the product characteristic indications 204 for the user regarding the product characteristics are denoted with marked boxes. It should be appreciated that the product characteristic indications can be provided to the user in any suitable manners. It should also be appreciated that the product characteristic indications can inform the user information regarding characteristics which the user prefers as inferentially determined by the system based on the user picked product images, or can inform the user of characteristics to focus on when the user is picking the product images. These indications of the characteristics can be as broad or as narrow as desired by the system implementer. The product characteristic indication section can additionally be used to enable the system to directly input or select user desired or preferred characteristics. In certain embodiments, the system groups these product characteristics. For example, product characteristics 1 to 5 could relate to one feature of the product where only one of the characteristics can be selected from that group. It should be appreciated that various other uses of the list of product characteristics and/or indications thereof can be employed in accordance with the present disclosure.

In this example, the user selects Product Type Z. More specifically, the system causes the user access device to display a product display page 210 which adjacently displays Product Image A labeled 214 and Product Image B labeled 216 as illustrated in FIG. 3C. The product of Product Image A is different from the product of Product Image B. In this example, the system indicates to the user that these images are being used in relation to product characteristic 1. The system also prompts the user to pick the product that the user likes better from the two displayed products such as by clicking on one of the displayed product images.

After the user picks one of the displayed product images, the system causes the user access device to display a product display web page 220 which adjacently displays Product Image A labeled 214 (which was the picked image from the previous set) and Product Image C labeled 226 as illustrated in FIG. 3D. The product of Product Image A is different from the product of Product Image C. The system indicates to the user that these images are being used in relation to product characteristic 2. The system prompts the user to pick the product that the user likes better from the two displayed products such as by clicking on one of the displayed product images.

After the user picks one of the displayed product images, the system causes the user access device to display a product display web page 230 which adjacently displays Product Image C labeled 226 and Product Image D labeled 228 as illustrated in FIG. 3E. The product of Product Image C is different from the product of Product Image D. The system indicates to the user that these images are being used in relation to product characteristic 3. The system prompts the user to pick the product that the user likes better from the two displayed products such as by clicking on one of the displayed product images. Although not shown, this system can repeat this process for any designated quantity of product images.

In this example embodiment, the system uses data associated with the user picked product images to select a specific product with the user desired characteristics that the system has determined based on the picks by the user. The system causes the user access device to display a product search result web page 290 generally illustrated in FIG. 3F which displays a specific product (i.e., Product C) labeled 293 which the system determined to be a product which will be liked by the user based on the product images selected by the user, and thus the desired characteristics. It should be appreciated that in this example, the Product C is the same as the product of Product Image C. It should of course be appreciated that this is a very simplistic example and that just picking a product based on the individual different characteristics may or may not result in a specific product desired by the user.

In this illustrated embodiment, the system also directly enables the user to purchase the selected product or facilitates the user's purchase of the selected product such as enabling the user to pick the Buy Product C button labeled 295 and when the user does so, by directing the user to a product provider system (such a retailer system) which enables the user to directly purchase the product with the desired product profile as generally illustrated in FIG. 3F. As mentioned above, the system could alternatively function to enable the user to purchase or find out more information regarding the product. In this example, the system also includes a similar product button 297 which enables the user to ask the system for other similar products based on the preferred characteristics that the system has determined for the product type Z based on the user picks.

### XI. System Implementation Example 3

In another example embodiment of the system of the present disclosure which is not illustrated, the system enables a user that has a general idea of the product they are looking for, but is not positive of the specific product they are looking for, to use the system. In one such example, the product type is a watch. The system enables the user to select Men's Watches as the product type in the product type section (which is in the left hand margin in the above example) and which lists all of the different products types that the system at that point in time will enable the users to look for.

In this example, the system list all of the major characteristics of the selected product type and displays them underneath (e.g., displays the characteristics of leather bands, black face, roman numerals, etc). The user knows that he wants a silver watch, with a white face, that is waterproof and would like to get it within two weeks. The system enables the user to check all of those product characteristics (such as by using the check boxes adjacent to the product characteristics in the above example) and then clicking on the search button. In this example, the system will also ask the user where he wants to search (e.g., globally, United States, or locally). In this example, the user selects the United States since he wants to insure delivery of his new watch within his the two week time period. Once selected, the system will only display sets of comparative product images of watches with those characteristics in the sequential sets of comparative product images. It should be appreciated that the system can be configured to enable the user to select all of the product characteristics, and in the event that the user does so, the system can limit the quantity of sets of comparative product images or conduct the product search steps immediately without displaying any comparative product images. Thus, the system can be configured to be used by: (1) a user that is looking for ideas of a product type to buy but has no specific parameters of the specific product of that product type they are looking for; (2) a user that has very specific parameters of the product they are looking for; or (3) a user that is anywhere in between.

### XII. System Implementation Example 4

It should be appreciated from the above, that the system can assist a user when the user knows exactly what the user wants. In such an example embodiment of the system of the present disclosure which is also not illustrated, the system enables a user that is looking for a new handbag and knows exactly what she wants and wants it as soon as possible to use the system to find a product provider of the desired handbag. At the system home page, the user selects the product category accessories and the product type of Women's Handbags in the left margin. The system then displays all of the characteristics of this product type. The user selects black, leather, shoulder strap, oversized, silver buckles, under $250, and selects the territory of Local within twenty-five miles. The system then searches the system's databases for products which meet these user inputted characteristics. The system provides a limited quantity of sets of product comparisons of product images of products which meet all of the user's directly inputted preferred characteristics or can immediately enable the user to be directed to a product provider with one or more products that meet all or most of the user preferred characteristics.

This example demonstrates that the system can be used inversely by this type of user. If the user cannot locate exactly the handbag she desires, in this example, the system enables the user to open up or broaden her selected characteristics. For example, the system enables the user to broaden the search within fifty miles, or go to under $400, etc.

### XIII. System Implementation Example 5

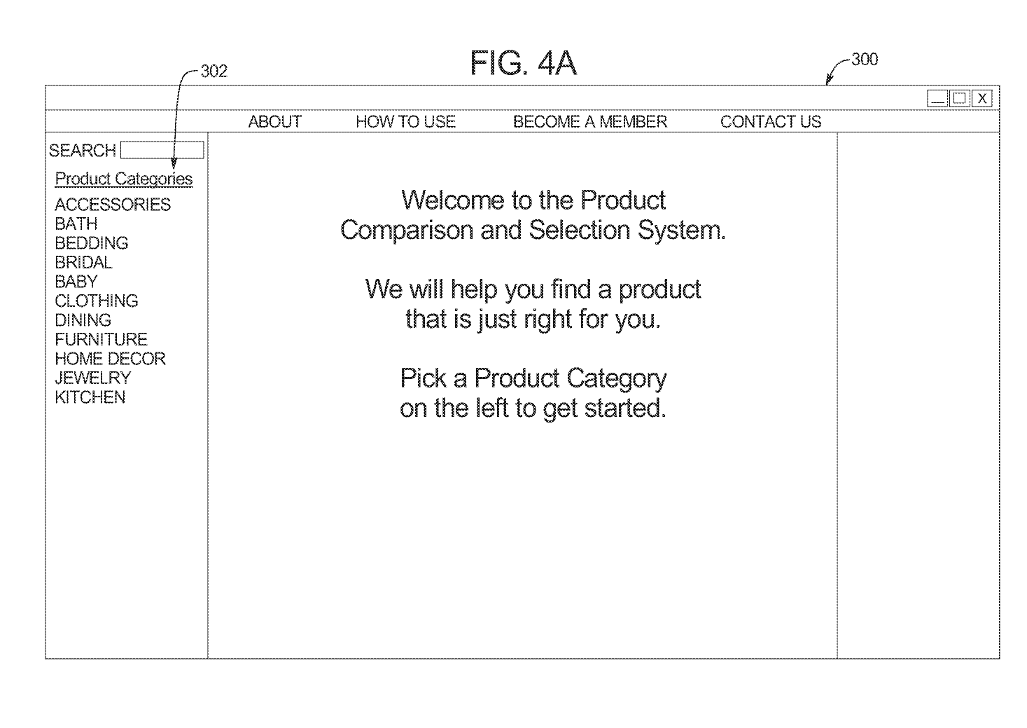

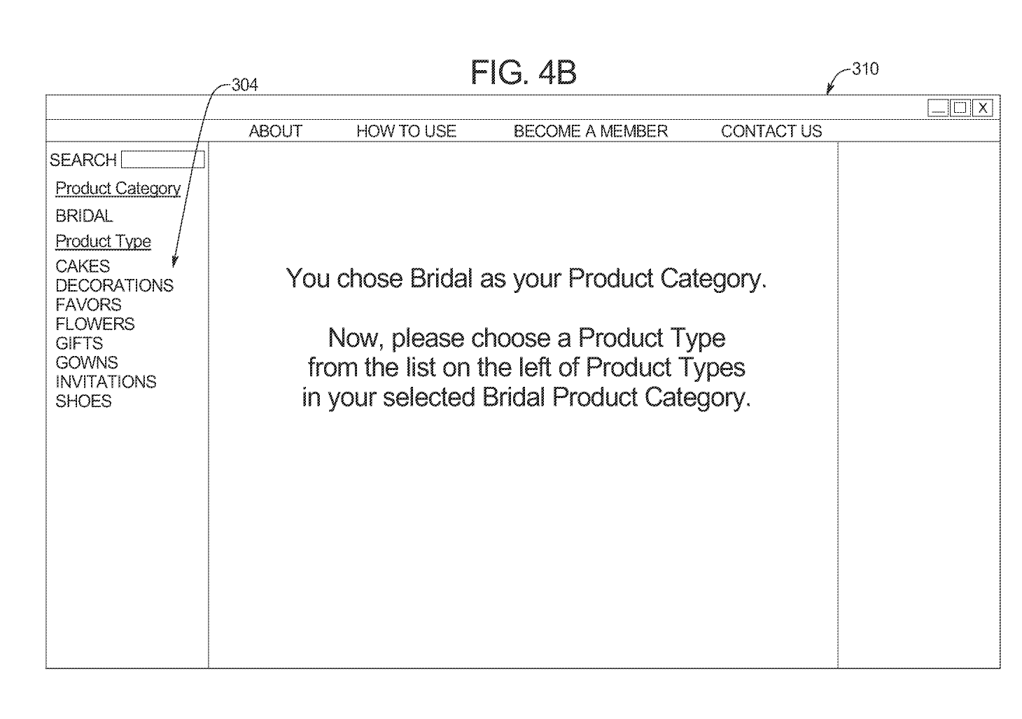

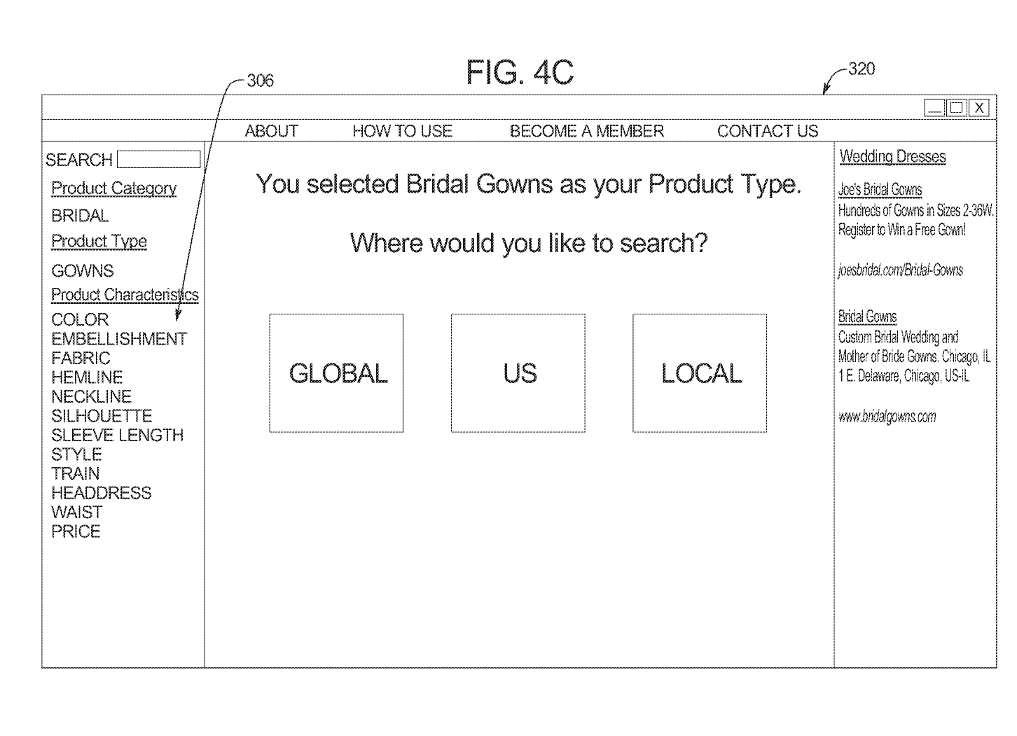

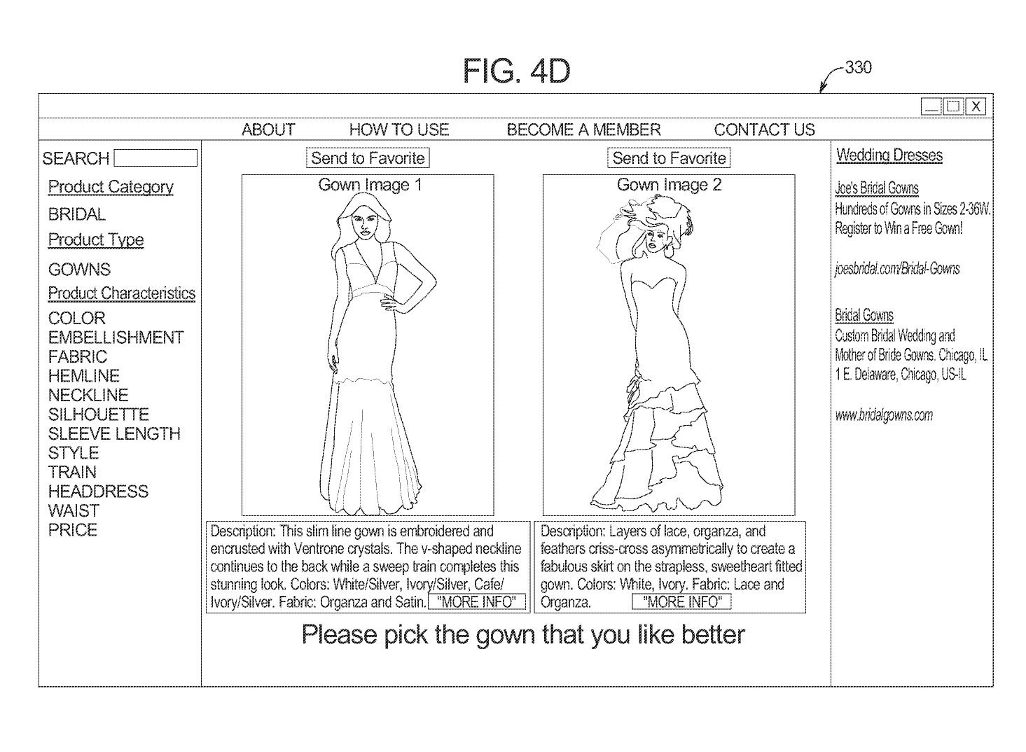

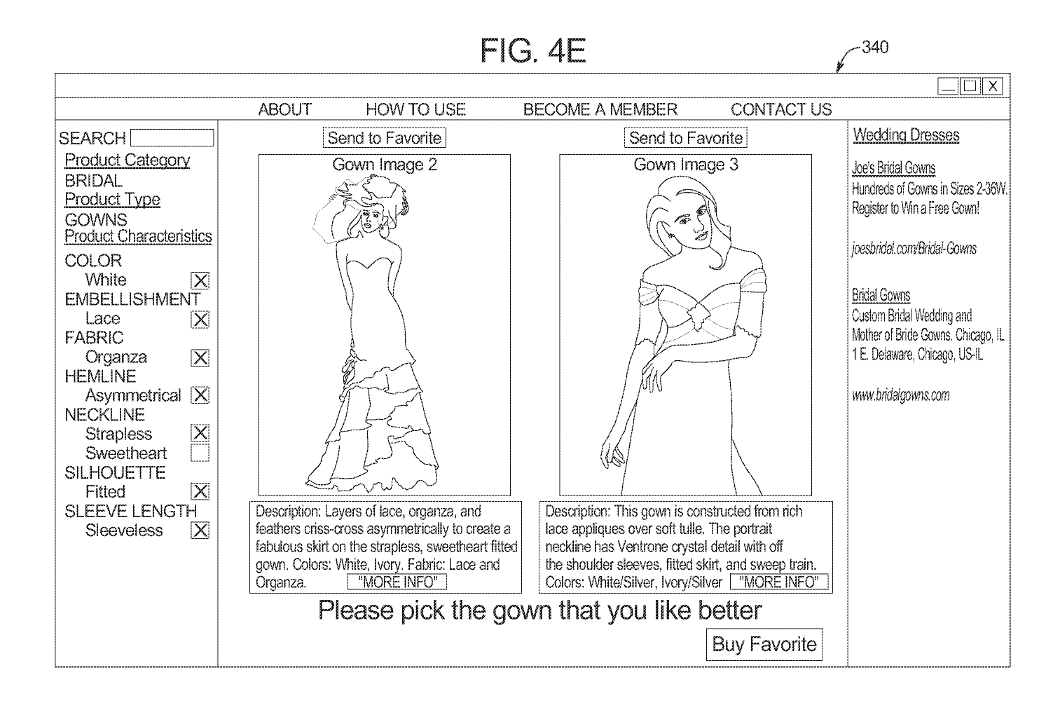

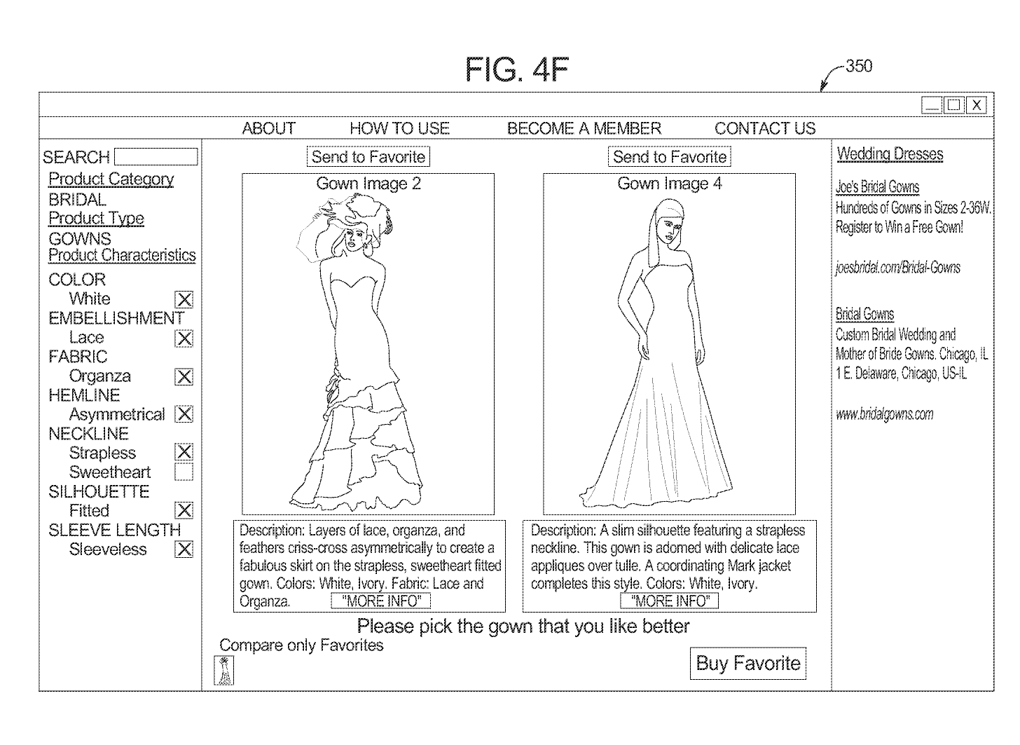

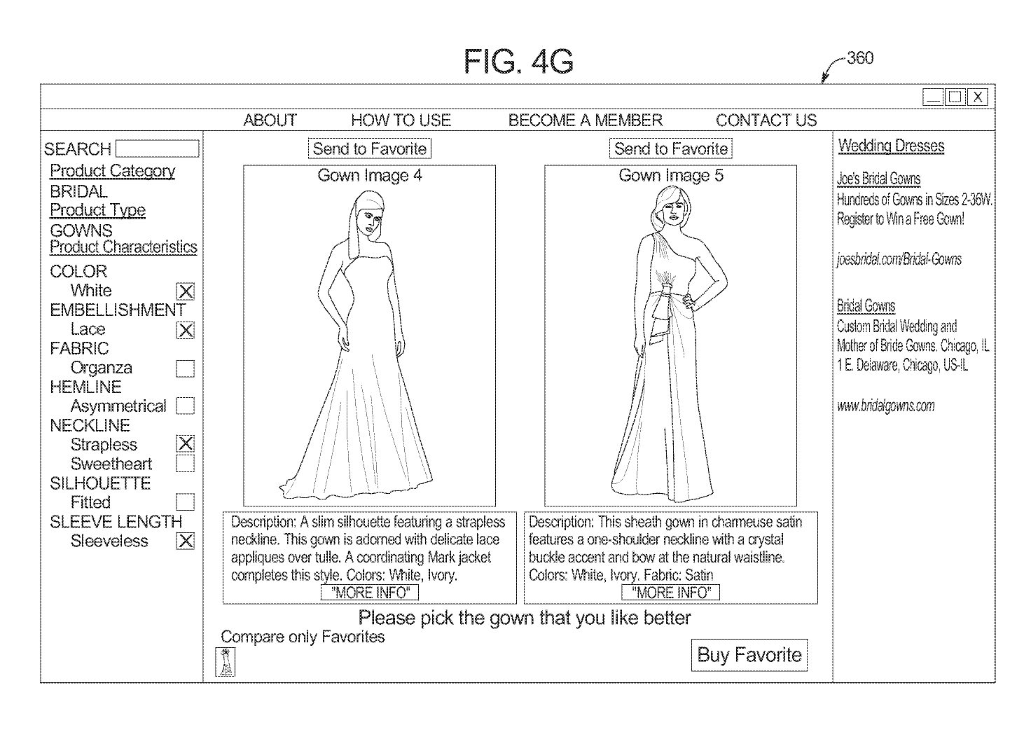

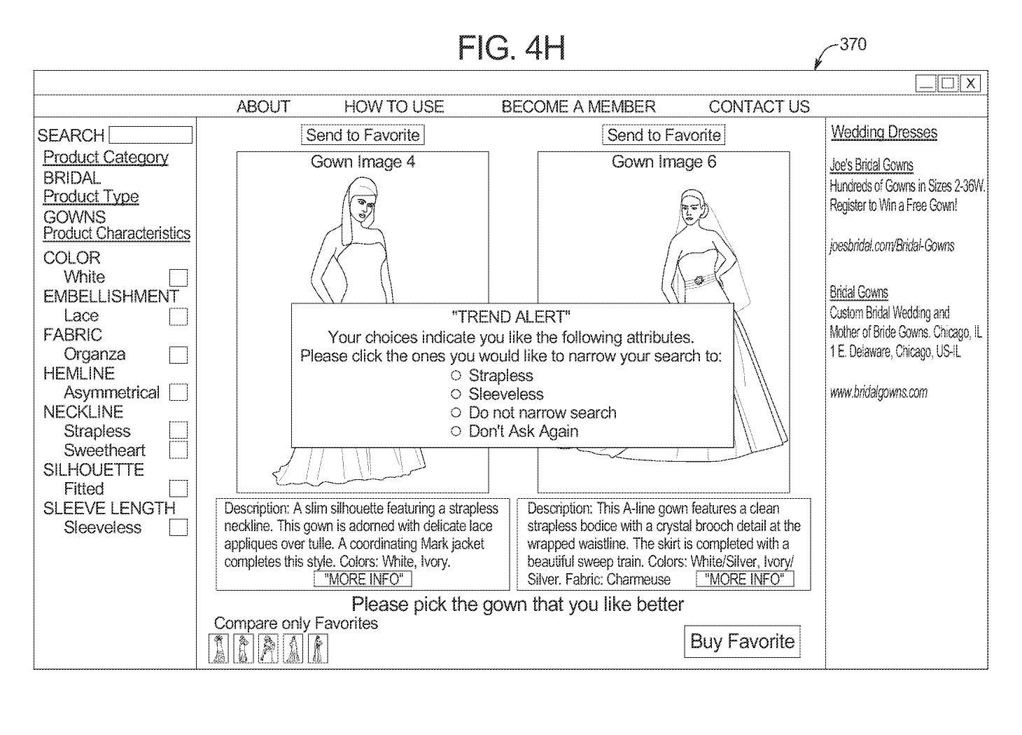

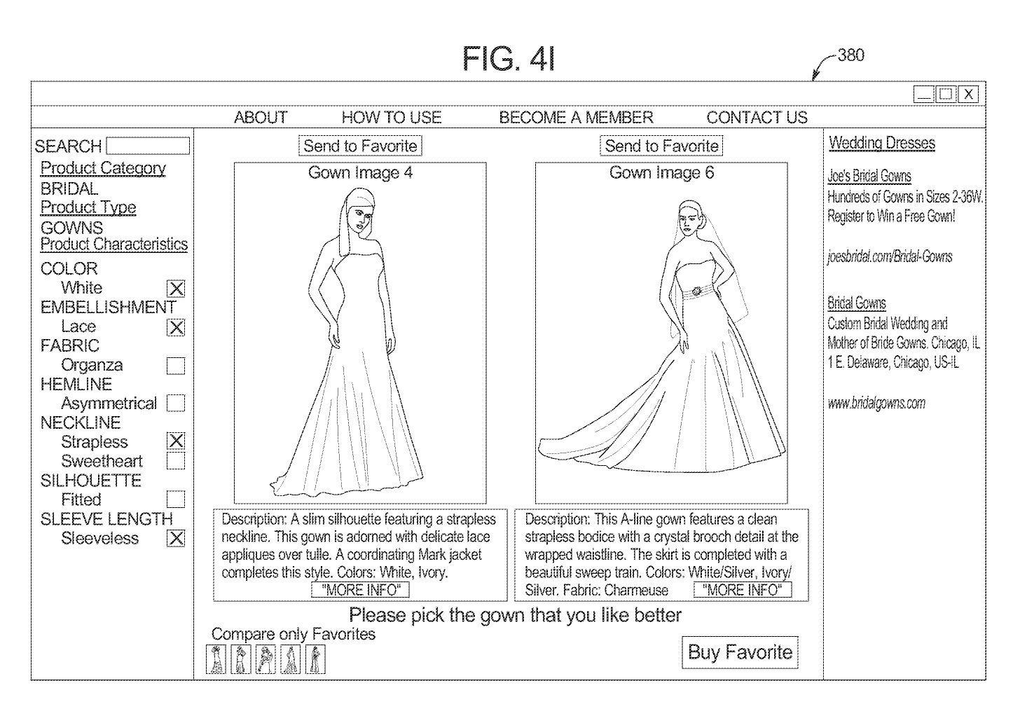

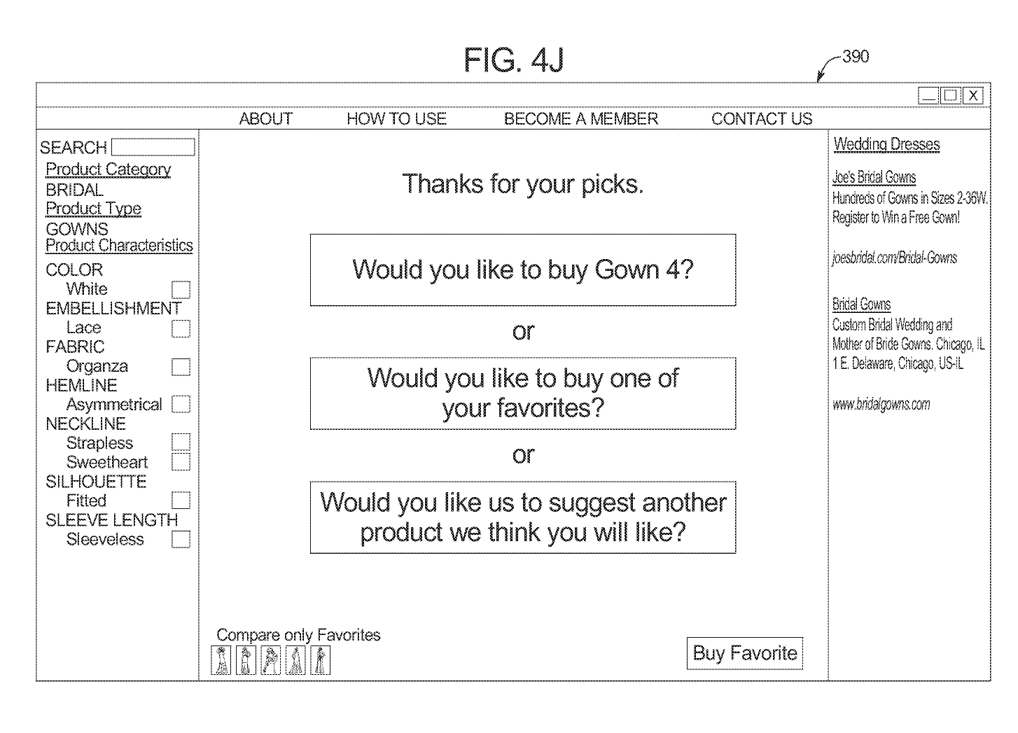

Turning now to FIGS. 4A, 4B, 4C, 4D, 4E, 4F, 4G, 4H, and 4J, another example embodiment of the product comparison and selection system of the present disclosure is illustrated. In this illustrated example certain embodiment, alternative and additional functions and features of the present disclosure are illustrated. In this example, the system enables a user to look for a particular product even though the user does not have any concrete idea of exactly what the user wants. This example uses bridal gowns as the product type. The user in this example is looking for ideas for her wedding gown for her wedding in twelve months.

After reaching the start or home search page 300 of the system as generally illustrated in FIG. 4A, the system first enables the user to select Bridal as the product category from a plurality of different product categories 302. In this illustrated example in FIG. 4B, the left hand side of the page 310 enables the user to the select Bridal Gowns as the product type (in the product category of Bridal) from the plurality of different product types 304. In this illustrated example, the left hand side of the pages 300 and 310 enable the user to make these selections and the center of each pages provides the user suitable guidance. It should be appreciated that these functions can be preformed by the system in any other suitable manner in accordance with the present disclosure. It should also be appreciated that in FIGS. 4A and 4B, the right hand side of the page is blank in this example because the user has not yet selected a product type. In this example, after the user selects a product type, the system populates the right hand side of the page with one or more product provider links and other information which relate to the specific product type as generally illustrated in FIG. 4C.

Additionally, once the product type of bridal gowns is selected, the system opens the product type of bridal gowns and displays a detailed list of the different product characteristics 306 for the wedding gown product type (such as sleeveless, backless, color, price, etc.) as generally shown on the left hand side of the page 320 in FIG. 4C. In this example, because the user does not know what she is looking for, the user does not select any of the specific characteristics at this point in time. In this example, the system enables the user to select characteristics, and the system also displays indications of selected characteristics based on the user picked images. It should be appreciated that the system can provide both or only one of those functions in different embodiments. The system also enables the user to input (such as by clicking on) the instruction to search for products.

The system asks the user to input or select the territory the user wants to search such as globally, within the US (or the respective country of the user), or locally as illustrated in the page 320 of FIG. 4C. If the user selects locally in this example embodiment, the system asks the user to select the choose a mileage distance from the user's location. In this example, the user selects global since the user is not getting married for twelve months and does not have any predetermined idea of what kind of wedding dress she is looking for.

After the user selects global, the system displays a page 330 with two product images of different wedding gowns in the middle of the page as illustrated in FIG. 4D. In this example embodiment, the system displays underneath each product image of a wedding gown a detailed description of certain of the characteristics of the respective wedding gown and a “More Info” button or link that the user can use to take or direct the user to the buy page of the displayed product and also provide more information than provided underneath the displayed image of the product.

The system prompts the user to pick the user's preferred product or wedding gown from the two displayed product images as generally illustrated in FIG. 4D. The user may do this such as by clicking on the product image.

If the user selects the product image on the left side, in this embodiment, the system will maintain the display of that selected product image on the left side and display a new product image of a different wedding gown on the right side as illustrated in the page 340 of FIG. 4E. More specifically, if the user selects the product image on the right side in FIG. 4D, the system maintains that product image for the next set of comparative product images. In this illustrated example, the user selected product image on the right moves to the left to become the left side product image for the next set of comparative product images as illustrated in FIG. 4E. The system also displays a new product image of a different product of the product type on the right side as also illustrated in FIG. 4E. In this example, the system also continues to display the product characteristics in the left margin. In this example, the system displays an indication of each characteristic that the user picked product image contains such as by checking a box in this example as illustrated in FIG. 4E.

As shown in FIG. 4E, in this example embodiment, the system also displays underneath each wedding gown product image a detailed description of certain of the characteristics of the respective wedding gown and a “More Info” button or link. The system again prompts the user to pick the user's preferred product or wedding gown from the two displayed product images as generally illustrated in FIG. 4E.

In this illustrated example, the user selects the product image on the left in FIG. 4E and that product image stays on the left for the next set of comparative product images as illustrated in the page 350 of FIG. 4F. The system also displays a new product image of a different product or wedding gown on the right side as also illustrated in FIG. 4F. In this example, the system also continues to display the product characteristics in the left margin. This now contains indications of further user desired characteristics of the weddings gown (i.e., the product type).

As shown in FIG. 4F, in this example embodiment, the system also displays underneath each wedding gown product image a detailed description of the respective wedding gown and a “More Info” button or link. The system again prompts the user to pick the user's preferred product or wedding gown from the two displayed product images as generally illustrated in FIG. 4F.

In this illustrated example, the user selects the product image on the right in FIG. 4F and that product image moves to the left for the next set of comparative product images as illustrated in the page 360 of FIG. 4G. The system also displays a new product image of a different product of the product type on the right side as also illustrated in FIG. 4G. In this example, the system also continues to display the product characteristics in the left margin, This now contains indications of further user desired characteristics of the product type.

As shown in FIG. 4G, in this example embodiment, the system also displays underneath each wedding gown product image a detailed description of the respective wedding gown and a “More Info” button or link. The system again prompts the user to pick the user's preferred product or wedding gown from the two displayed comparative product images as further illustrated in FIG. 4G.

It should be appreciated that the system will enable the user to continue with this process as she is looking for ideas for wedding gowns. In one embodiment, the system provides the user with the ability to collect or “favorite” up to a designated quantity of displayed product images to go back to. In one embodiment, such as shown in FIGS. 4G and 4H, the system will display these product images in small thumbnail images along the bottom of the page. At any time, the system will enable the user to select to just do a visual comparison of all of the user's favorites up to a designated quantity of favorites. It should be appreciated that the system can provide this type of functionality in a variety of different manners.

Through picking favorites from the series of comparative product images, the system enables the user to begin to define the user desired product profile of the wedding dress she likes best. In other words, after the user has gone through a system designated number of sets of comparative product images such as ten sets of comparative product images, the system will determine the user's preferred characteristics for the product type based on the product images that the user picks as her favorites.

In one embodiment, after a designated triggering event such as any of these characteristics reaching 50% of the previous ten favorite product images, the system displays to the user a “TREND ALERT” notice (which is in the form of a pop up window in this example embodiment). It should be appreciated that the designated triggering event can be based on any suitable formula determined by the system operator or implementor. This notice identifies that the user continues to pick or has picked product images which have one or more particular product characteristics a designated quantity of times as generally illustrated in the page 370 of FIG. 4H. In other words, the system has directly or inferentially identified a trend in the user's product characteristic preferences and is telling the user about this trend. In this illustrated example, the system asks the user if the user wants to see only dresses with those characteristics (i.e., change from the compare mode to the similar mode) or to continue as is (i.e., remain in the compare mode). If the user selects “YES”, the system will only subsequently display wedding gowns with those system determined user preferred characteristics for the product type. In certain embodiments, the system also indicates the system determined user preferred characteristics or desired product profile in the left hand margin. In one embodiment, the system also provides an input for the user to request no further trend alerts (such as a box to check stating “Don't Ask Again”) should the user not want the same “Trend Alert” in the future. Thus, from this example, it should be appreciated that the system enables the user to switch from the “COMPARE” mode to the “SIMILAR” mode where the system subsequently only displays product images of products that have the so far determined user desired characteristics.

In certain embodiments, the user can “FAVORITE” up to a designated quantity such as ten dresses that she can go back to in both the compare mode or the similar mode to help in the effort to define and fine tune her desired characteristics in a wedding dress. As illustrated in the pages 380 of FIG. 41, in this example, the system provides a button or link that says “BUY FAVORITE.” When the user clicks on this button, the system takes the user to a product provider's site which enables the user to buy that favorite product. It should be appreciated that the system can allow an unlimited quantity of favorites in other embodiments.

FIG. 4J further illustrates certain example choices that the system can provide to the user to assist the user in finally selecting a product after the user picks from all of the sets of product images, It should be appreciated that the system in various embodiments can provide other alternatives or options such as, but not limited to enabling the user to go through one or more additional sets of comparative product images or enabling the user to go through all of the product images of the product type.

It should thus be appreciated from this example that through repeated visual comparison of product images, trend alerts, and the ability to favorite up to a designated number of total product images to compare to each other, the system will enable the user to narrow down the desired characteristics of the wedding gown she is looking for ultimately bringing her to the wedding gown she would like to purchase.

### XIV. System Implementation Example 6

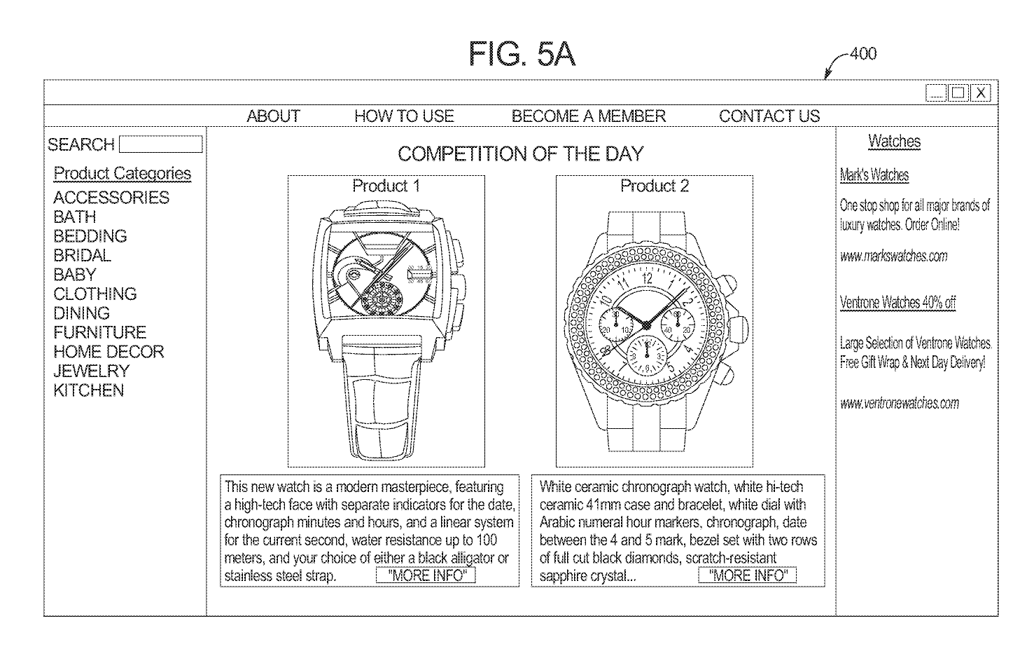

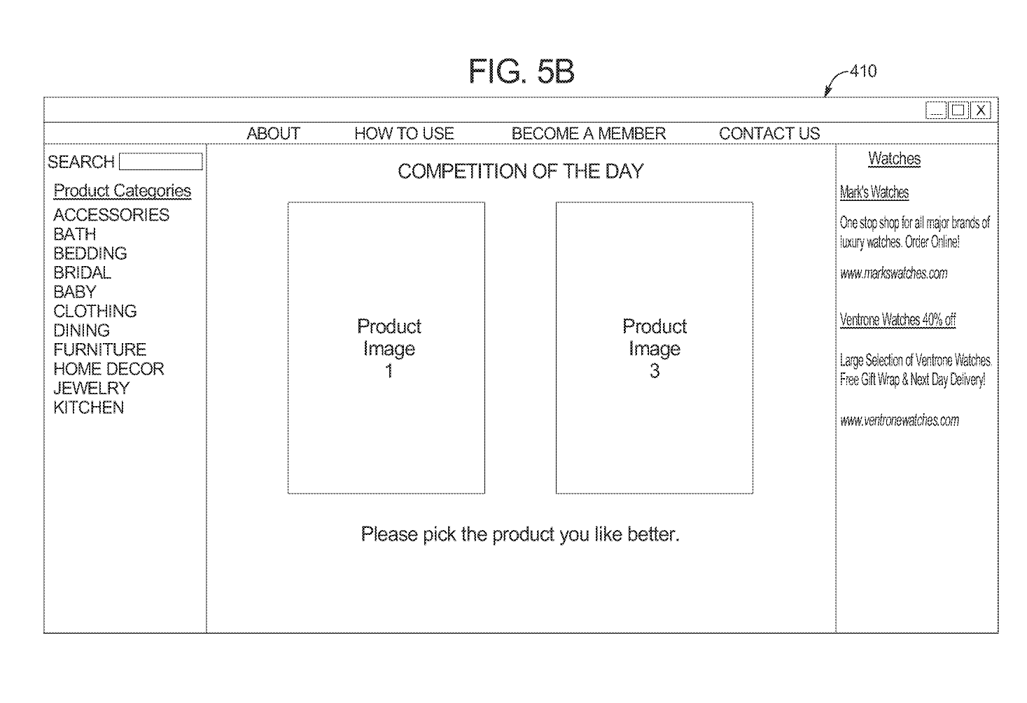

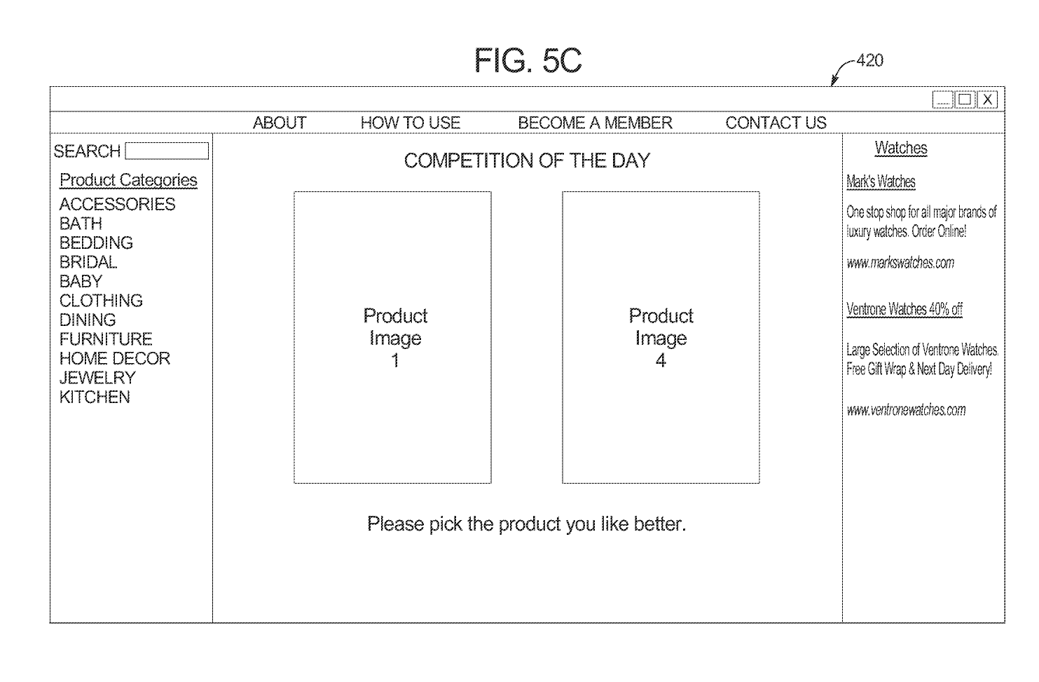

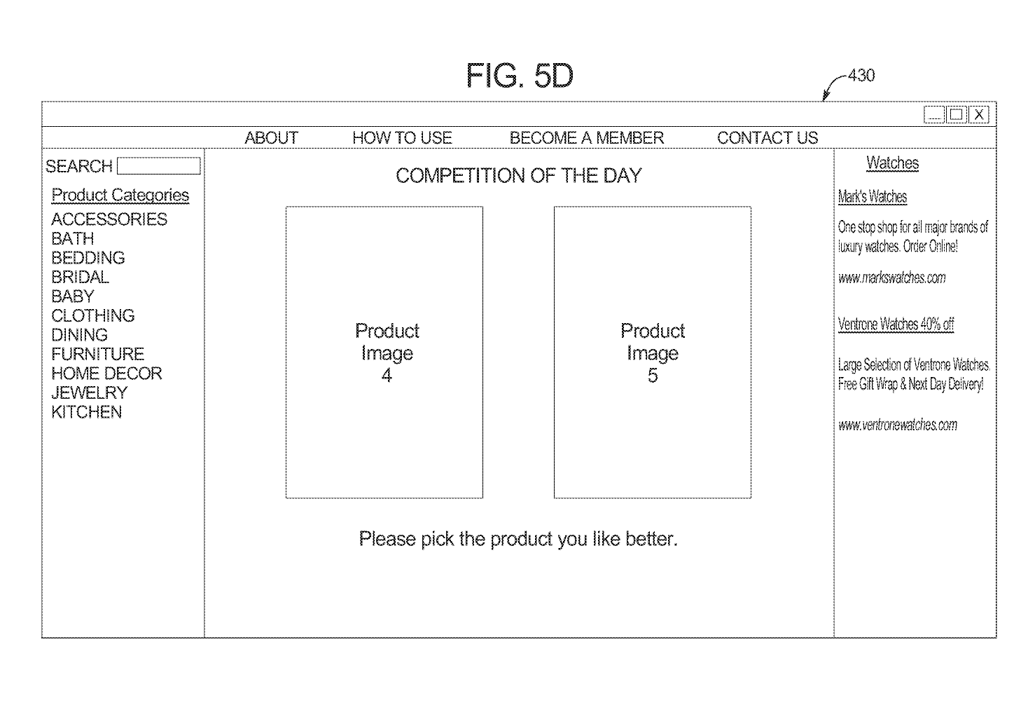

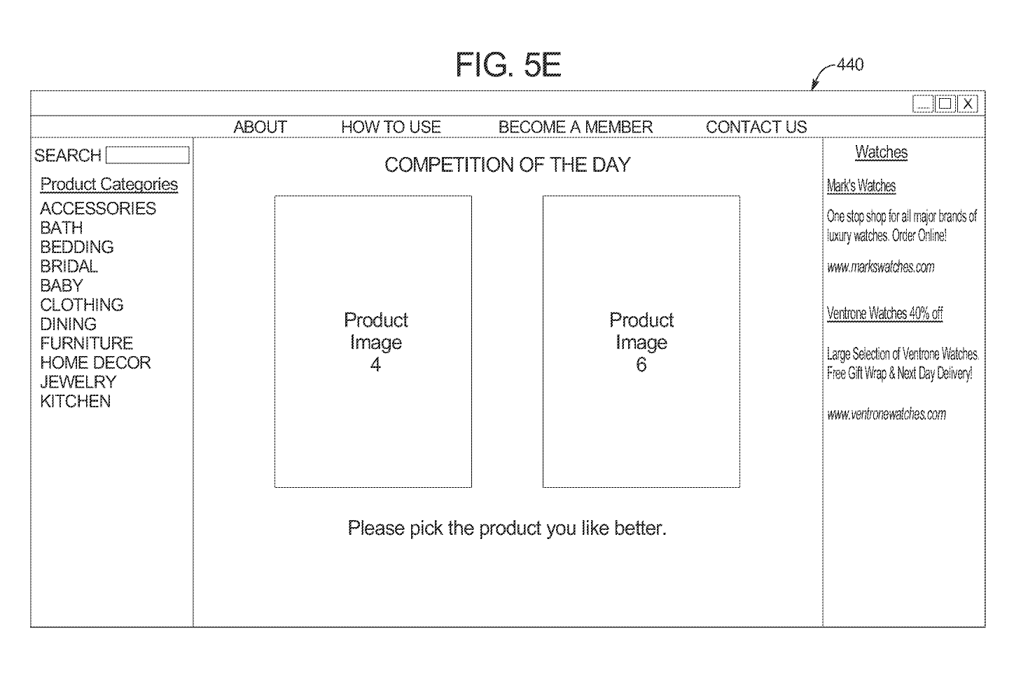

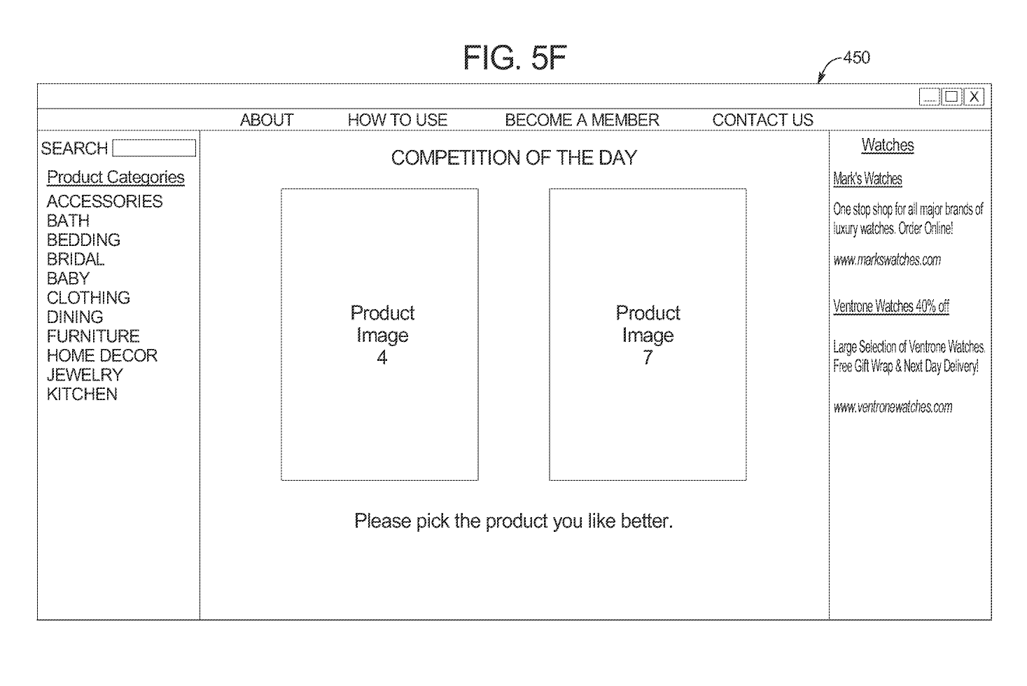

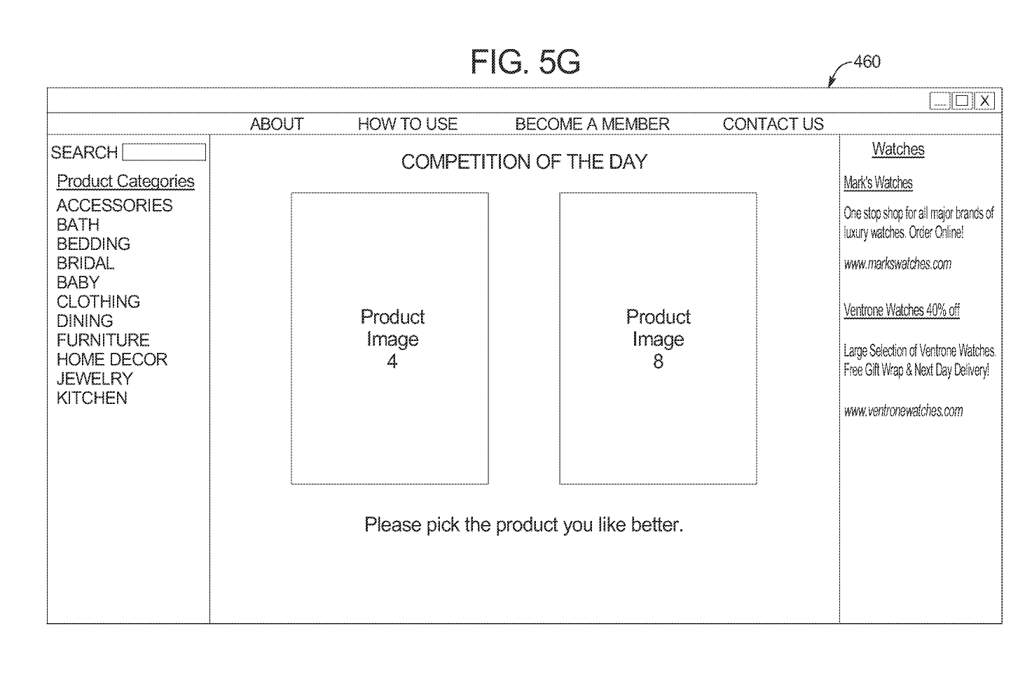

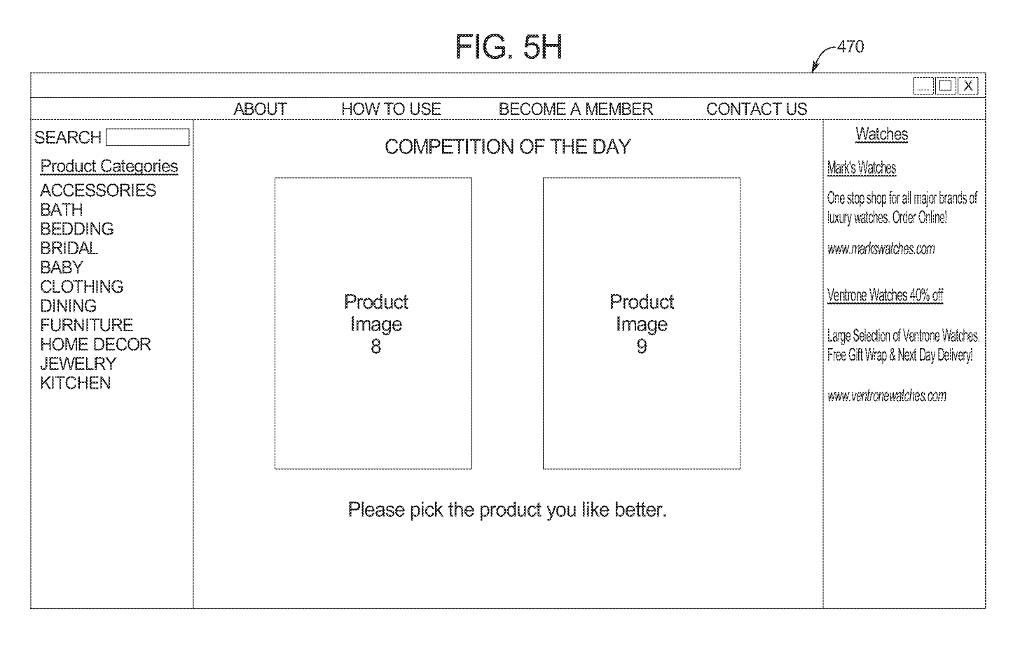

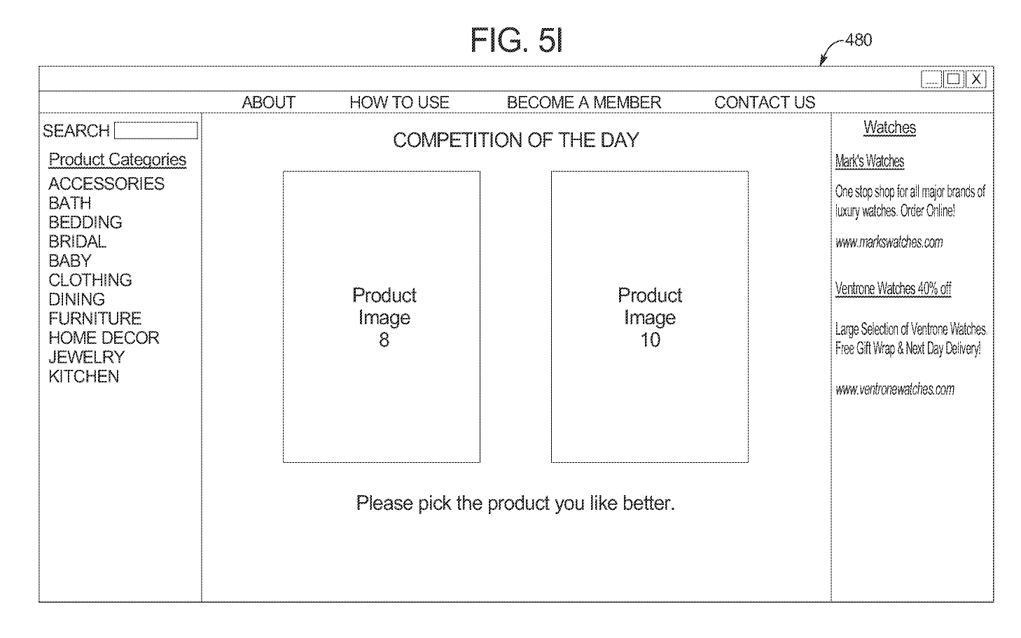

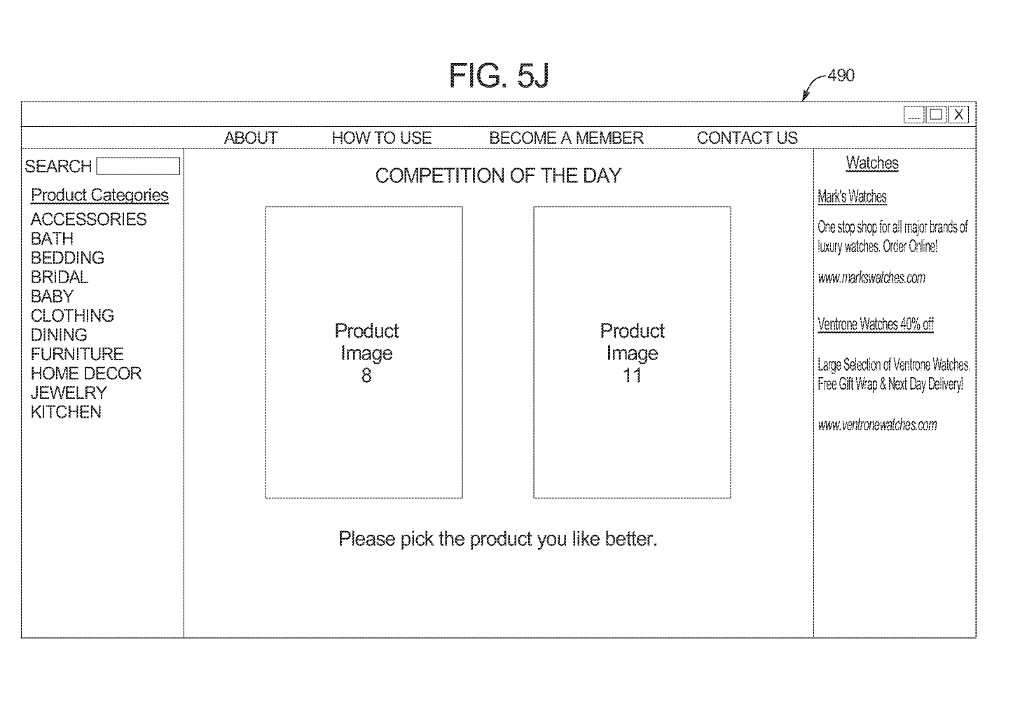

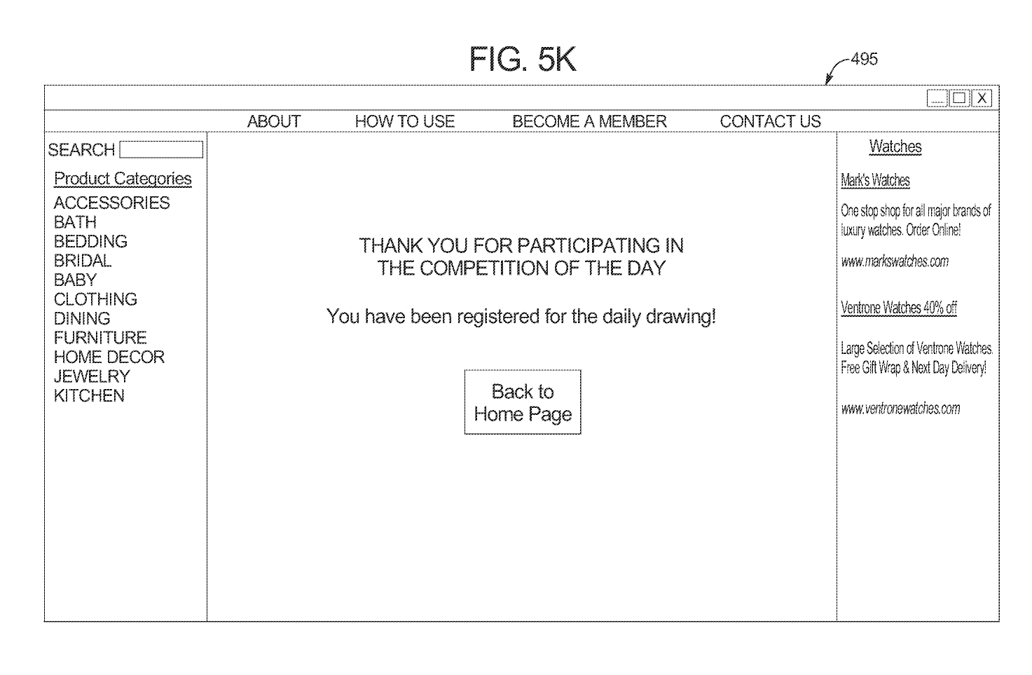

Turning now to FIGS. 5A, 5B, 5C, 5D, 5E, 5F, 5G, 5H, 5I, 5J, and 5K, another example embodiment of the system of the present disclosure is illustrated. In this example embodiment, the system selects a product type from a plurality of different product types and enables users to each interactively choose their favorite products of that system selected product type.

In certain embodiments, the system does this on a regular basis such as once a day (i.e., one new product each day). In this example, the system employs a product competition of the day.

The system can select the product types in any suitable manner. In one embodiment, the system predetermines the products for each designated time period. In another embodiment, the system randomly selects the product types from a plurality of different product types for each designated time period.

In this example embodiment, the system employs a competition structure for the set of comparative product images of the products of the selected product type by the user. In this example, the competition is for users who have signed up as members of the system.

In this example embodiment, the system provides the winner of the competition with a prize of a designated amount (such as $100) for participating in the product competition. In this example embodiment, the system can be used by members and non-members, but only members will be eligible for the prize. In addition, in this example embodiment, the system provides the retailer that provides the product images with a payment (such as $100).

In this example, the user will be able to enter or use the system by logging onto a product selection system home page 400 such as illustrated in FIG. 5A. The left hand margin has a list of all the product categories which can be searched through this system implementation. This interface enables the user to skip the competition and immediately start to look for a product or participate in the competition.

In this example, the system provides ten sets of comparative product images for the user to choose from one set at a time; however, the number of sets may vary.

In this embodiment, the system displays advertisements or other information for one or more product provider on a section of the page 400 (such as on the right hand side of the page). In advance of the daily competition in this example, the system notifies retailers in the market of the product selected for the competition to determine if they want to advertise on the home page during the designated time period (such as a day) for the competition. It is anticipated that the system will charge advertising fees sufficient enough to cover the cost of paying at least one user and at least one retailer the award as set forth above (i.e., the $200 per day being spent on the winners). It should also be appreciated that these advertising fees can ultimately become an additional profit source for the system implementer or operator. In the example illustrated in FIGS. 5A to 5K, the competition is about watches (i.e., product images 1 to 11 are all of watches) and thus the advertisements on the right hand side of the pages relate to the product type of watches. It should be appreciated that while example watches are actually illustrated in FIG. 5A, FIGS. 5D to 5J simply generally represent different images of watches and that all of the product images displayed will be of actual watches in this example.

FIGS. 5A to 5J show a series of pages 410, 420, 430, 440, 450, 460, 470, 480, and 490 which provide sets of comparative product images to the user and ask the user to sequentially pick from each set. After the user picks an image from each set, the system displays a thank you page 495 shown in FIG. 5K which indicates to the user that the user has finished participation in the competition and is registered for the daily drawing.

### XV. System Implementation Example 7

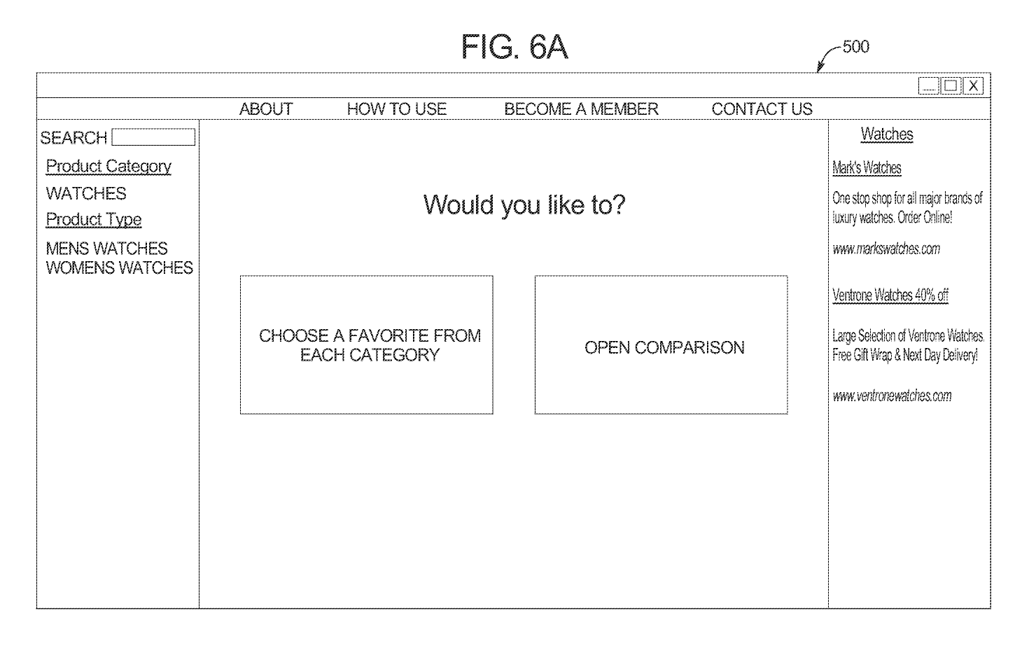

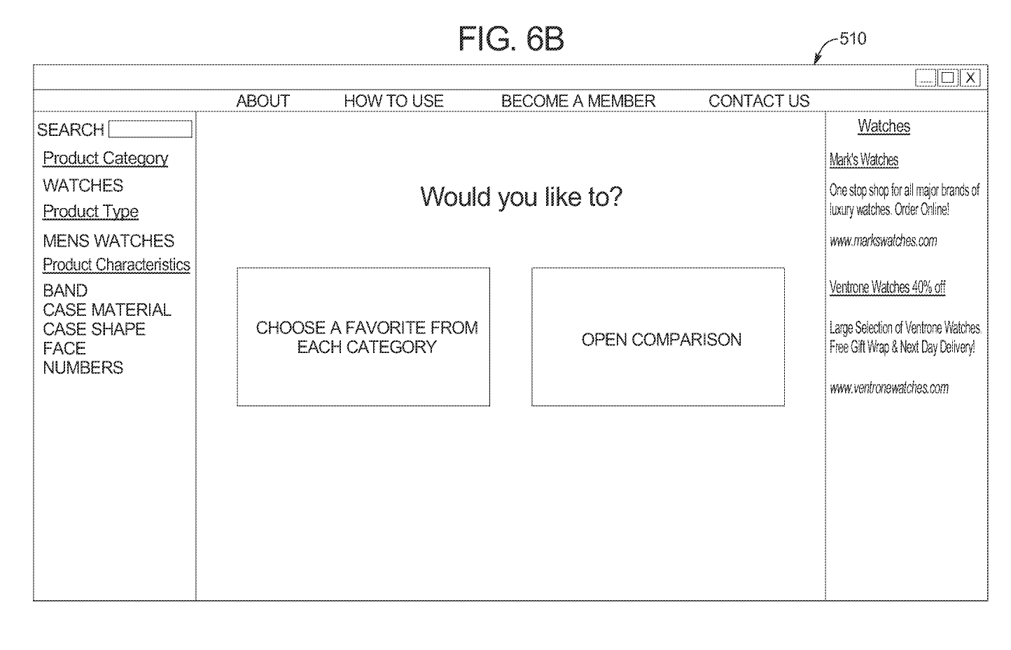

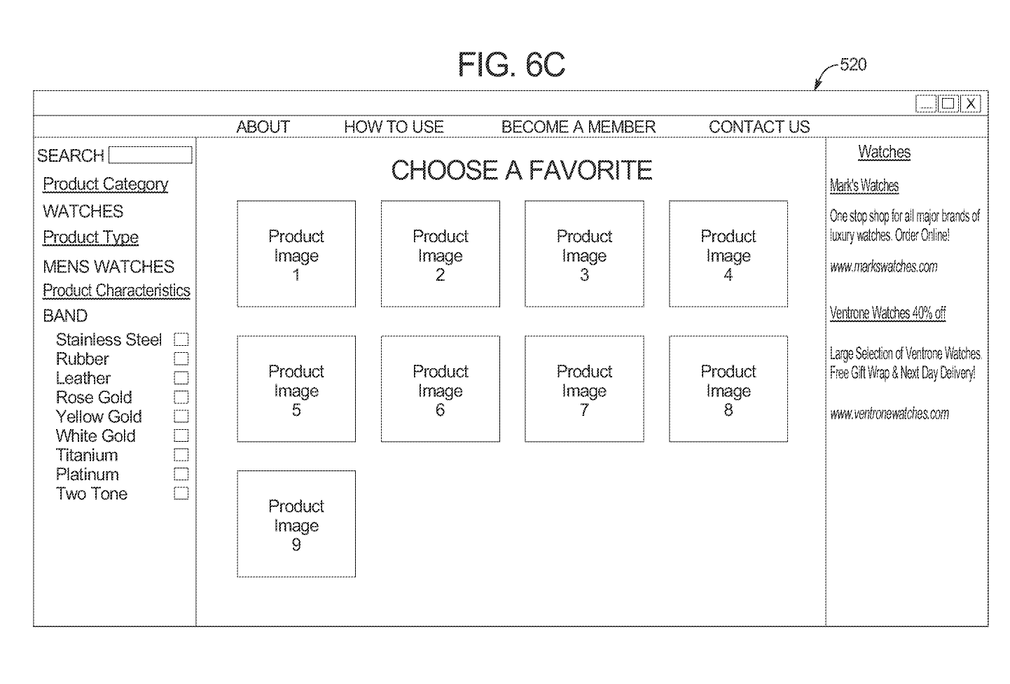

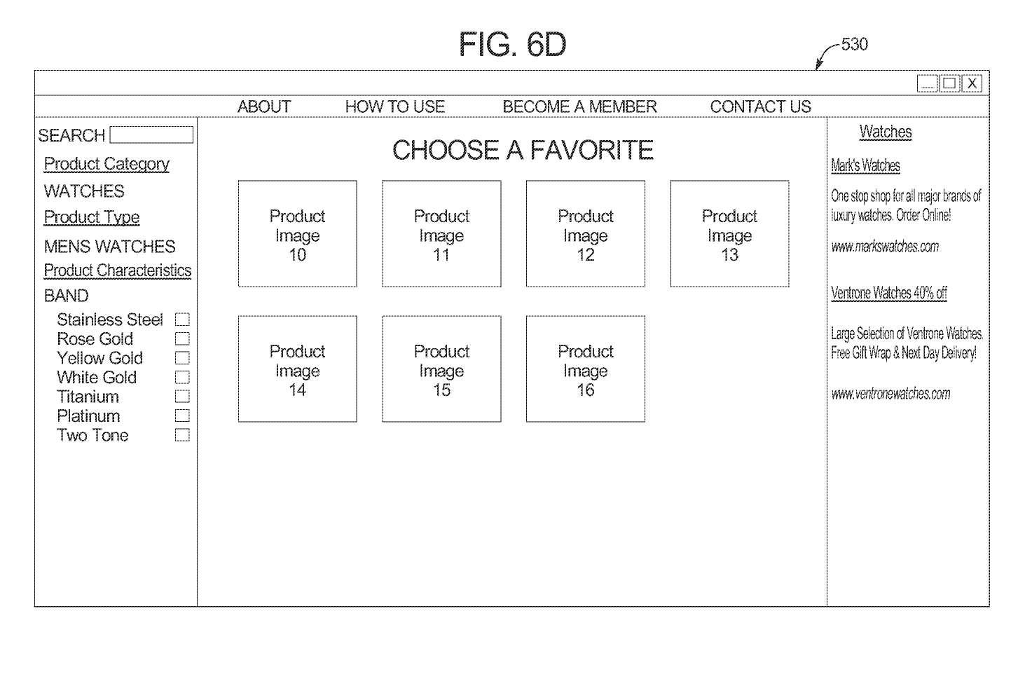

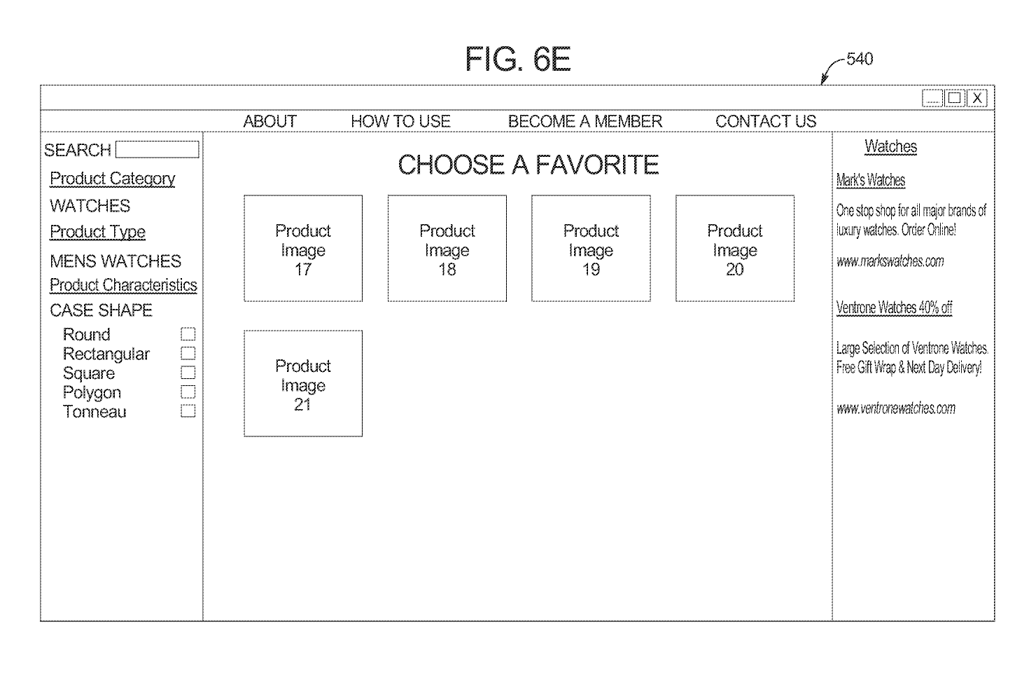

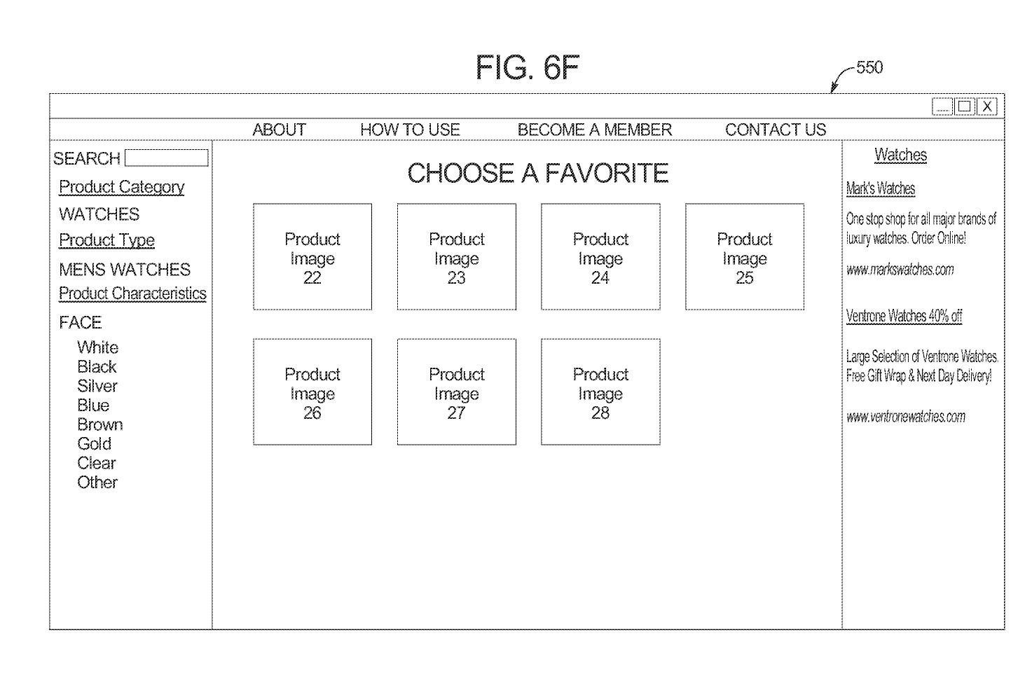

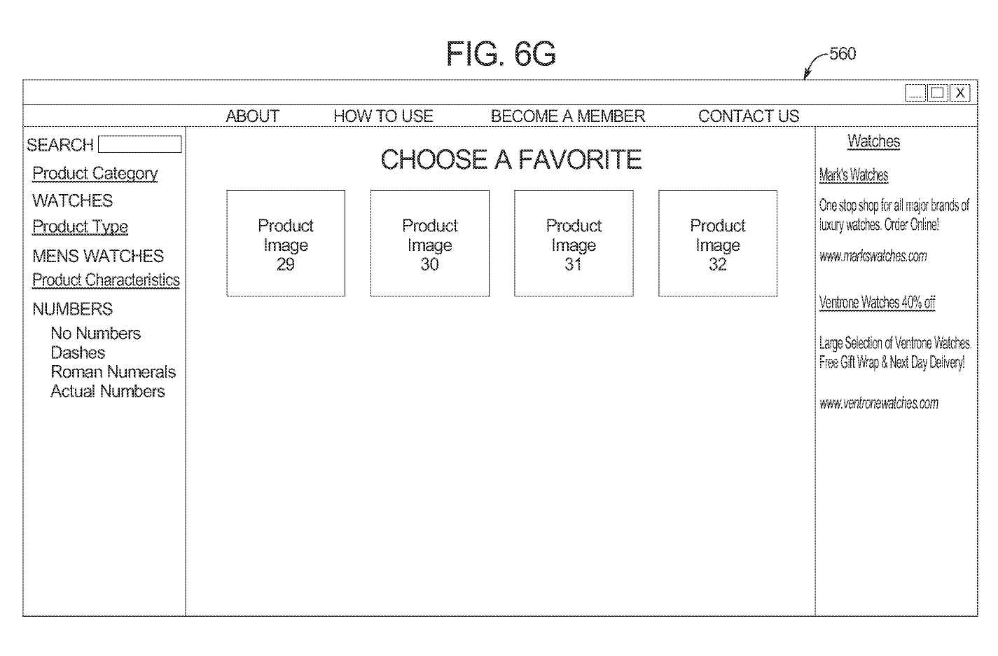

Turning now to FIGS. 6A, 6B, 6C, 6D, 6E, 6F, and 6G, the user interfaces or pages 500, 510, 520, 530, 540, 550, and 560 of another example embodiment of the product comparison and selection system of the present disclosure are generally illustrated.

In this example, the user access device (not shown) enables the user to access the product comparison and selection system though a home page 500 as generally illustrated in FIG. 6A. After the user accesses the home page of the system, the system asks the user to and enables the user to select a product category and then a product type from a list of displayed different product types (which are maintained by the system). In this embodiment, the user has selected the Product Category of Watches and the Product Type of Men's Watches as shown by FIGS. 6A and 6B. It should be appreciated that in the above examples watches are a product type, but in this example watches are a product category. It should be appreciated from this example that the system operator or implementer can configure the product categories and product types of the system in any suitable manner.

In FIGS. 6A and 6B, the system asks the user if they would like to choose a favorite from each category or take part in the open product comparison (as described above), In this example, the user selects to choose a favorite from each category. In this example, the system displays multiple product images organized by groups of characteristics. More specifically, after the user makes the selection to choose a favorite from each category, the system causes the user access device to sequentially display to the user of a plurality of sets of comparative visual product images of different versions of the products of the user picked product type and enables the user to sequentially pick one of the displayed visual product images of the products from each set of displayed visual product images to step by step to enable the system to determine the user preferred or desired product characteristics for the product type (i.e., the desired product profile).

The system causes the user access device to display a product display page which adjacently displays nine (men's watch) product images as illustrated in the page 520 of FIG. 6C. The product images are different in one specific characteristic and particularly the color of the band in FIG. 6C. The system prompts the user to pick the product that the user likes better from the displayed products such as by clicking on one of the displayed product images.

After the user picks one of the displayed product images in FIG. 6C, the system causes the user access device to display a product display page 530 which adjacently displays seven (men's watch) product images as illustrated in FIG. 60. The product images are different in one specific characteristic and particularly the type of band in FIG. 6D. The system prompts the user to pick the product that the user likes better from the displayed products such as by clicking on one of the displayed product images.

After the user picks one of the displayed product images in FIG. 6D, the system causes the user access device to display a product display page 540 which adjacently displays five (men's watch) product images as illustrated in FIG. 6E, The product images are different in one specific characteristic and particularly the shape of the face of the watch in FIG. 6E. The system prompts the user to pick the product that the user likes better from the displayed products such as by clicking on one of the displayed product images.

After the user picks one of the displayed product images in FIG. 6E, the system causes the user access device to display a product display page 550 which adjacently displays seven (men's watch) product images as illustrated in FIG. 6F. The product images are different in one specific characteristic and particularly the color of the watch face in FIG. 6F. The system prompts the user to pick the product that the user likes better from the displayed products such as by clicking on one of the displayed product images.

After the user picks one of the displayed product images in FIG. 6F, the system causes the user access device to display a product display page 560 which adjacently displays five (men's watch) product images as illustrated in FIG. 6G. The product images are different in one specific characteristic and particularly the type of numbers of the watch in FIG. 6G. The system prompts the user to pick the product that the user likes better from the displayed products such as by clicking on one of the displayed product images.

In this example embodiment, the system sequentially walks the user through each group of characteristics with the product characteristic indications and the groups of product images. The system uses data associated with the user picked product images to determine a desired product profile and select a specific product with most or all of the user desired characteristics of the desired product profile that the system has determined based on the picks by the user. The system causes the user access device to display a product search result page (not shown) which displays a specific product which the system determined to be a product which will be liked by the user based on the product images selected by the user, and thus the desired characteristics.

### XVI. Additional Advantages for The Product Providers Such as Retailers

It should be appreciated from the above that the product comparison and selection system of the present disclosure provides multiple advantages to product providers such as product sellers. It should also be appreciated that; (1) the system enables product providers (such as retailers) to advertise their products directly through the product images that the product providers provide the system; (2) the system enables product providers (such as retailers) to advertise their products on the system and specifically on the pages of the system directly to a user who is looking for the products the providers are advertising; (3) the system enables smaller or local product providers such as retailers to advertise their products; (4) the system enables larger or more global product providers to advertise their products; and (5) the system enables new product providers to open up their products globally, simply, efficiently, and at a reasonably low cost.

### XVII. Additional Advantages for the User(s)

It should be appreciated from the above that the product comparison and selection system of the present disclosure provides multiple advantages to users. It should also be appreciated that the system: (1) the system can assist a user without any idea of a defined product; (2) the system can assist a user who has a somewhat or partially defined product; (3) the system can assist a user who has a very defined product; (4) the system can be used in reverse by a user who has very defined product to find the closest style product to what they are looking for; (5) the system enables a user to quickly compare and select products, and avoids long product searches; and (6) the system shortens the shopping time while defining the product that the user desires or directly finding what the user already has defined in a relatively short period of time.

It should also be appreciated that in certain embodiments of the system of the present disclosure, the system enables users to enter product reviews of various products and displays or makes these reviews available to other users. In certain embodiments of the system of the present disclosure, the system enables the users to see or access product reviews by non-users of the system. It should be appreciated that other suitable product review systems can be employed in conjunction with the system of the present disclosure to provide users the benefit of seeing product reviews for products they are searching for or which result from use of the system. It should further be appreciated that in various embodiments of the present disclosure, the system selects the comparative product images to display to the user based in part on one or more product reviews. For example, the system can select the products with better product reviews to display to the user. It should also be appreciated that other suitable product rating systems can be employed in conjunction with or used by the system of the present disclosure.

It should also be appreciated that the product comparisons provided by the system of the present disclosure can be presented to the user or accessed by a user in different formats or through different systems. For example, it should be appreciated that the product comparisons provided by the system of the present disclosure can be presented to the user in the form of one or more suitable games. It should be appreciated that such games can be configured for play by a single user or multiple users. In another example, it should be appreciated that the product comparisons provided by the system of the present disclosure can be presented to the user through one or more social network systems such as Facebook. It should be further appreciated that such social network system can be configured for access by a single user or multiple users.

Thus, it should further be appreciated that the system contemplates that in a game environment, in a social network environment, or in a regular or non-game non-social network environment (as described above), the system can be configured to enable multiple people to make inputs for the same product search and the respective product comparisons. For example, the system will enable a bride and a groom to make inputs for the same search or the same sets of product comparisons. In certain embodiments, the multiple user function can be provided by the system sequentially where each user reviews their own set of comparative product images and makes their decisions or inputs independently, In such case, the system selects the product based on all of the user inputs. In other embodiments, the multiple user function can be provided by the system simultaneously where each user reviews the set of comparative product images and they make their decisions or inputs jointly.

It should also be appreciated that in certain embodiments of the system of the present disclosure, the system enables users to use obtain more information about their favorites and to compare their favorites. For example, the system can enable the user to cause the system to display a side by side comparison of two of the user's favorites.

### XVIII. Additional Advantages for System Operators or Implementers.

It should be appreciated from the above that the product comparison and selection system of the present disclosure provides multiple advantages to system operators or implementers. It should also be appreciated that: (1) the system operator can charge a product provider for each product image displayed by the system; (2) the system operator can provide discounts to product providers for displaying multiple product images; and (3) the system can be used by anyone in the world which has a user access devices(i.e., the target market is the global consumer or anyone looking to search for or buy a product).

### XIX. Computerized Devices For System Implementation

As mentioned above, the present disclosure contemplates that the product comparison and selection system of the present disclosure is configured to communicate with one or more product provider systems and one or more user access devices. As also mentioned, the present disclosure contemplates that the system is implemented through a web site, a downloadable application, or through the combination of both.

The present disclosure contemplates that the user access devices include any suitable user computer and/or computerized communication device. As stated above, such devices include but are not limited to: (a) a desktop computer; (b) a laptop computer; (c) a smart phone; (e) a tablet computing device; and (f) a personal digital assistant.

It should be appreciated that the processor(s) of the user access devices can be any suitable type of processor(s) such as but not limited to one or more microprocessor(s) from the INTEL family of microprocessors.

It should be appreciated that the memory or data storage device(s)of the user access devices can be any suitable type of memory or data storage device which includes volatile memory and non-volatile memory such as but not limited to: random access memory (RAM), non-volatile RAM (NVRAM), magnetic RAM (MRAM), ferroelectric RAM (FeRAM), read only memory (ROM), flash memory, and/or EEPROM (electrically erasable programmable read only memory), other suitable magnetic memory devices, any optical memory device, or any semiconductor based memory devices). It should also be appreciated that the memory or data storage device(s) can be configured in any suitable manner to store part or all of the program code and/or operating data for performing the functions described herein for the user access devices. The user access devices may also include a hard drive, CD drive, DVD drive, and/or other storage devices suitably connected to processor(s).

The memory or data storage devices store one or more software programs executable by the processor(s) to enable the user access devices to enable the user perform the above described functions.

It should be appreciated that the display device(s) of the user access devices can be any suitable type of display devices such as but not limited to a conventional computer monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image. The display devices at least partially generate the visual displays of or relating to the user interfaces or pages of the product comparison and selection system described above. It should be appreciated that as described above, the visual displays display prompts for user inputs as described above. It should also be appreciated that the system can include or be connected to one or more printers for printing the visual displays.

It should be appreciated that the input devices can be any suitable type of input devices such as but not limited to: (a) a keyboard; (b) a mouse; (c) a touch-screen input device; (d) a track pad; (e) a track ball; and (f) a voice recognizer.

In various embodiments, the product selection system also includes one or more processors, one or more memory devices, one or more display devices, and one or more input devices. As with the user access devices, the processors, memory devices, display devices, and input devices of the product selection system can be any of those devices as described above. The display devices and the input devices of the product selection system are configured to be used by one or more operators of the product selection system to operate or run the system.

It should further be appreciated that the product selection system may operate with the product provider systems and the user access devices through any suitable wired, partially wired, or wireless data network. Thus, it should be appreciated that the system of the present disclosure can operate through any suitable central or remote network such as but not limited to a local area network (LAN), a wide area network (WAN), an intranet, and the Internet (such as through cloud computing). It should also be appreciated that the system may also exchange data with other network devices via a connection to a data network. The network connection may be any suitable type of network connection, such as an Ethernet connection, digital subscriber line (DSL), telephone line, coaxial cable, etc. It should thus be appreciated that some or all of the data storage and/or data analysis functions of the system can be done remotely from any of the other systems or devices.

In various embodiments, the product provider systems also include one or more processors, one or more memory devices, one or more display devices, and one or more input devices. As with the user access devices, the processors, memory devices, display devices, and input devices of the product provider systems can be any of those devices as described above. The display devices and the input devices of the product provider systems are configured to be used by one or more operators of the product provider systems to operate or run those systems.

It will be understood that modifications and variations may be effected without departing from the scope of the novel concepts of the present invention, and it is understood that this application is to be limited only by the scope of the claims.

The invention is claimed as follows:

1. A product selection system comprising:
at least one memory device; and
at least one processor, said at least one processor configured to operate with the at least one memory device, at least one product provider system, and a user access device to:
(a) use product data from the at least one product provider system;
(b) receive from the user access device data representing a user-selected product type from a plurality of different product types;
(c) cause the user access device to sequentially display a plurality of sets of comparative product images of different products of the user selected product type;
(d) for each of the sets of displayed comparative product images, receive from the user access device data representing a user pick of one of the displayed comparative product images of said set;
(e) for each of the sets of displayed comparative product images, use data associated with the user picked comparative product image of said set to at least partially determine a user-desired characteristic of the user-selected product type;
(f) select a specific product of the user-selected product type based on the determined user-desired characteristics of the user-selected product type; and
(g) cause the user access device to display an indication of said specific product.

2. The product selection system of claim 1, wherein the at least one processor is configured to use product data from a plurality of product provider systems.

3. The product selection system of claim 1, wherein the at least one processor is configured to cause at least one of the displayed comparative product images of at least one of the sets of the displayed comparative product images to include one of the displayed comparative product images from a previously displayed set of comparative product images.

4. The product selection system of claim 1, wherein the at least one processor is configured, after a first set of displayed comparative product images, to cause each sequentially displayed set of comparative product images to include one of the displayed comparative product images from any previously displayed set of comparative product images.

5. The product selection system of claim 1, wherein the at least one processor is configured to cause each of the displayed comparative product images of at least one set of displayed comparative product images to be different from each of the displayed comparative product images from a previously displayed set of comparative product images.

6. The product selection system of claim 1, wherein the at least one processor is configured, after a first set of displayed comparative product images, to cause each of the displayed comparative product images of each of the sets of displayed comparative product images to be different from each of the displayed comparative product images from any previously displayed sets of comparative product images.

7. The product selection system of claim 1, wherein the displayed indication of said specific product includes an image of the specific product.

8. The product selection system of claim 1, which is configured to facilitate a purchase of the specific product of the user-selected product type.

9. The product selection system of claim 1, which is configured to enable a user to determine the at least one product provider system by geographic area.

10. The product selection system of claim 9, wherein the geographic area includes one of: a plurality of countries, a single country, and a designated area in a country.

11. The product selection system of claim 1, wherein the at least one processor causes the user access device to display one or more additional indicators of one or more characteristics of the user-selected product type with at least one set of displayed comparative product images.

12. The product selection system of claim 1, wherein the at least one processor is configured to switch from a compare mode to a similar mode if a designated quantity of user-desired characteristics of the user-selected product type are determined.

13. The product selection system of claim 12, wherein the at least one processor is configured to automatically switch from the compare mode to the similar mode.

14. The product selection system of claim 12, wherein the at least one processor is configured to enable a user to switch from the compare mode to the similar mode.

15. The product selection system of claim 12, wherein, in the similar mode, the at least one processor causes each of any subsequently displayed comparative product images to be of products having said determined user-desired characteristics.

16. The product selection system of claim 12, wherein the at least one processor causes the user access device to display a notification of a switch from the compare mode to the similar mode.

17. The product selection system of claim 12, wherein the at least one processor causes the user access device to switch from the compare mode to the similar mode without displaying a notification of the switch.

18. The product selection system of claim 12, wherein the at least one processor causes the user access device to display an indication of the determined user-desired characteristics of the user-selected product type.

19. The product selection system of claim 12, wherein the at least one processor causes the user access device to enable a user to approve the determined user-desired characteristics of the user-selected product type or to change one or more of the determined user-desired characteristics of the user-selected product type.

20. The product selection system of claim 12, wherein the at least one processor causes the user access device to enable a user to input one or more user-desired characteristics of the user-selected product type.

21. A product selection system comprising:
at least one memory device; and
at least one processor, said at least one processor configured to operate with the at least one memory device and a user access device to:
(a) receive from the user access device data representing a user-selected one of a plurality of different product categories;
(b) receive from the user access device data representing a user-selected one of a plurality of different product types of said user-selected product category;
(c) determine comparative product images of said user-selected product type;
(d) sequentially display sets of said comparative product images; and
(e) for each of said sets of displayed comparative product images, receive from the user access device data representing a user-selected one, but not all, of the displayed comparative product images from said set of displayed comparative product images.

22. The product selection system of claim 21, wherein the at least one processor is configured to cause at least one of the displayed comparative product images of at least one of the sets of displayed comparative product images to include one of the displayed comparative product images from a previously displayed set of comparative product images.

23. The product selection system of claim 21, wherein the at least one processor is configured, after a first set of displayed comparative product images, to cause each sequentially displayed set of comparative product images to include one of the displayed comparative product images from a previously displayed set of comparative product images.

24. The product selection system of claim 21, wherein the at least one processor is configured to cause each of the displayed comparative product images of at least one set of displayed comparative product images to be different from each of the displayed comparative product images from a previously displayed set of comparative product images.

25. The product selection system of claim 21, wherein the at least one processor is configured, after a first set of displayed comparative product images, to cause each of the displayed comparative product images of each of the sets of displayed comparative product images to be different from each of the displayed comparative product images from any previously displayed sets of comparative product images.

26. The product selection system of claim 26, wherein the geographic areas includes one of: a plurality of countries, a single country, and a designated area in a country.

27. The product selection system of claim 21, wherein the at least one processor causes the user access device to display one or more additional indicators of one or more characteristics of the user-Indicated product type with at least one set of displayed comparative product images.

28. The product selection system of claim 21, wherein the at least one processor is configured to switch from a compare mode to a similar mode if a designated quantity of user-preferred characteristics of the user-indicated product type are determined.

29. The product selection system of claim 28, wherein the at least one processor is configured to automatically switch from the compare mode to the similar mode.

30. The product selection system of claim 28, wherein the at least one processor is configured to enable a user to switch from the compare mode to the similar mode.

31. The product selection system of claim 28, wherein, in the similar mode, the at least one processor causes each of any subsequently displayed comparative product images to be of products having said determined user-preferred characteristics.

32. The product selection system of claim 28, wherein the at least one processor causes the user access device to display a notification of a switch from the compare mode to the similar mode.

33. The product selection system of claim 28, wherein the at least one processor causes the user access device to switch from the compare mode to the similar mode without displaying a notification of the switch.

34. The product selection system of claim 28, wherein the at least one processor causes the user access device to display an indication of the determined user preferred characteristics of the user-indicated product type.

35. The product selection system of claim 34, wherein the at least one processor causes the user access device to enable a user to approve the determined user-preferred characteristics of the user-indicated product type or to change one or more of the determined user-preferred characteristics of the user-indicated product type.

36. The product selection system of claim 28, wherein the at least one processor causes the user access device to enable a user to input one or more user-preferred characteristics of the user-indicated product type.

37. A product selection system comprising:
at least one memory device; and
at least one processor, said at least one processor configured to operate with the at least one memory device and a user access device to:
(a) sequentially display a plurality of sets of comparative product images of a product type selected by a user;
(b) for each of said sets of displayed comparative product images, receive from the user access device data representing a user selected one, but not all, of the displayed comparative product images from said set of displayed comparative product images, wherein at least one of the displayed comparative product images of at least one of the sets of the plurality of displayed comparative product images includes one of the product images from a previously displayed set of comparative product images;
(c) for each of the sets of displayed comparative product images, use data associated with the user-selected comparative product image of said set to at least partially determine a user-desired characteristic of the product type;
(d) select a specific product of the product type based on the determined user desired characteristics of the product type; and
(e) cause the user access device to display an indication of said specific product.

38. The product selection system of claim 37, wherein the at least one processor is configured, after a first set of displayed comparative product images, to cause each sequential set of displayed comparative product images to include one of the displayed comparative product images from a previously displayed set of comparative product images.

39. A product selection system comprising:
at least one memory device; and
at least one processor, said at least one processor configured to operate with the at least one memory device and a user access device to:
(a) sequentially display a plurality of sets of comparative product images of a product type selected by a user;
(b) for each of said sets of displayed comparative product images, receive from the user access device data representing a user selected one, but not all of the displayed comparative product images from said set of displayed comparative product images, wherein each of the displayed comparative product images of at least one set of the displayed comparative product images is different from each of the displayed comparative product images from a previously displayed set of comparative product images;
(c) for each of the sets of displayed comparative product images, use data associated with the user-selected comparative product image of said set to at least partially determine a user-desired characteristic of the product type;
(d) select a specific product of the product type based on the determined user-desired characteristics of the product type; and
(e) cause the user access device to display an indication of said specific product.

40. The product selection system of claim 39, wherein the at least one processor is configured, after a first set of displayed comparative product images, to cause each of the displayed comparative product images of each of the sets of displayed comparative product images to be different from each of the displayed comparative product images from the previously displayed sets of comparative product images.

41. A product selection system comprising:
at least one memory device; and
at least one processor, said at least one processor configured to operate with the at least one memory device and a user access device to:
(a) cause the user access device to sequentially display a plurality of sets of comparative product images of a product type selected by a user;
(b) for each of said sets of displayed comparative product images, receive from the user access device data representing a user-selected one, but not all, of the displayed comparative product images from said set of displayed comparative product images;
(c) for each of a plurality of said sets of displayed comparative product images, receive from the user access device data representing an additional user-selected comparative product image; and
(d) after each selection of a comparative product image, cause the user access device to enable a display of one or more of the user-selected comparative product images in addition to any subsequent display of the sets of comparative product images.
